(19) United States
(12) Patent Application Publication
(10) Pub. No.: US 2015/0103924 A1
(43) Pub. Date: Apr. 16, 2015

(54) ON OPERATION OF DECODED PICTURE BUFFER FOR INTERLAYER PICTURES

(71) Applicant: Sharp Laboratories of America, Inc., Camas, WA (US)

(72) Inventors: Kiran MISRA, Vancouver, WA (US); Sachin G. DESHPANDE, Camas, WA (US)

(21) Appl. No.: 14/513,661

(22) Filed: Oct. 14, 2014

Related U.S. Application Data
(60) Provisional application No. 61/890,307, filed on Oct. 13, 2013.

(51) Int. Cl. H04N 19/587

(52) U.S. Cl. CPC H04N 19/587
USPC 375/240.26

(57) ABSTRACT

A system for decoding a video bitstream includes receiving a bitstream and a plurality of enhancement bitstreams together with receiving a video parameter set and a video parameter set extension. The system also receives an information in slice header that enables marking of inter-layer pictures as “unused for reference”

### CROSS-REFERENCE TO RELATED APPLICATIONS

This application claims the benefit of U.S. Provisional App. No. 61/890,307, filed Oct. 10, 2013.

### TECHNICAL FIELD

The present disclosure relates generally to electronic devices. More specifically, the present disclosure relates to electronic devices for signaling sub-picture based hypothetical reference decoder parameters.

### BACKGROUND OF THE INVENTION

Electronic devices have become smaller and more powerful in order to meet consumer needs and to improve portability and convenience. Consumers have become dependent upon electronic devices and have come to expect increased functionality. Some examples of electronic devices include desktop computers, laptop computers, cellular phones, smart phones, media players, integrated circuits, etc.

Some electronic devices are used for processing and displaying digital media. For example, portable electronic devices now allow for digital media to be consumed at almost any location where a consumer may be. Furthermore, some electronic devices may provide download or streaming of digital media content for the use and enjoyment of a consumer.

The increasing popularity of digital media has presented several problems. For example, efficiently representing high-quality digital media for storage, transmittal and rapid playback presents several challenges. As can be observed from this discussion, systems and methods that represent digital media efficiently with improved performance may be beneficial.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1A is a block diagram illustrating an example of one or more electronic devices in which systems and methods for sending a message and buffering a bitstream may be implemented.

FIG. 1B is another block diagram illustrating an example of one or more electronic devices in which systems and methods for sending a message and buffering a bitstream may be implemented.

FIG. 2 is a flow diagram illustrating one configuration of a method for sending a message.

FIG. 3 is a flow diagram illustrating one configuration of a method for determining one or more removal delays for decoding units in an access unit.

FIG. 4 is a flow diagram illustrating one configuration of a method for buffering a bitstream.

FIG. 5 is a flow diagram illustrating one configuration of a method for determining one or more removal delays for decoding units in an access unit.

FIG. 6A is a block diagram illustrating one configuration of a decoder on an electronic device.

FIG. 6B is another block diagram illustrating one configuration of a decoder on an electronic device.

FIG. 7 is a block diagram illustrating one configuration of a method for operation of a decoded picture buffer.

FIG. 8 illustrates a general NAL Unit syntax.

FIG. 9 is an exemplary picture prediction configuration.

FIG. 10 illustrates an exemplary layer dependency structure and the associated values for a corresponding array.

FIG. 11 illustrates an exemplary layer dependency structure and the associated values for a corresponding array.

### DEFINITIONS AND NOTATIONS

Ceil(x) represents the smallest integer greater than or equal to x

Log 2(x) represents the base-2 logarithm of x

The following relational operators are defined as follows:

> Greater than.
>= Greater than or equal to.
< Less than.
<= Less than or equal to.

### □□ Equal to.

!= Not equal to.

The following logical operators are defined as follows:

x && y Boolean logical “and” of x and y.
x∥y Boolean logical “or” of x and y.
! Boolean logical “not”.
x?y:z If x is TRUE or not equal to 0, evaluates to the value of y; otherwise, evaluates to the value of Z.

### DETAILED DESCRIPTION OF PREFERRED EMBODIMENT

An electronic device for sending a message is described. The electronic device includes a processor and instructions stored in memory that is in electronic communication with the processor. The electronic device determines, when a Coded Picture Buffer (CPB) supports operation on a sub-picture level, whether to include a common decoding unit CPB removal delay parameter in a picture timing Supplemental Enhancement Information (SEI) message. The electronic device also generates, when the common decoding unit CPB removal delay parameter is to be included in the picture timing SEI message (or some other SEI message or some other parameter set e.g. picture parameter set or sequence parameter set or video parameter set or adaptation parameter set), the common decoding unit CPB removal delay parameter, wherein the common decoding unit CPB removal delay parameter is applicable to all decoding units in an access unit from the CPB. The electronic device also generates, when the common decoding unit CPB removal delay parameter is not to be included in the picture timing SEI message, a separate decoding unit CPB removal delay parameter for each decoding unit in the access unit. The electronic device also sends the picture timing SEI message with the common decoding unit CPB removal delay parameter or the decoding unit CPB removal delay parameters.

The common decoding unit CPB removal delay parameter may specify an amount of sub-picture clock ticks to wait after removal from the CPB of an immediately preceding decoding unit before removing from the CPB a current decoding unit in the access unit associated with the picture timing SEI message.

Furthermore, when a decoding unit is a first decoding unit in an access unit, the common decoding unit CPB removal delay parameter may specify an amount of sub-picture clock ticks to wait after removal from the CPB of a last decoding unit in an access unit associated with a most recent buffering period SEI message in a preceding access unit before removing from the CPB the first decoding unit in the access unit associated with the picture timing SEI message.

In contrast, when the decoding unit is a non-first decoding unit in an access unit, the common decoding unit CPB removal delay parameter may specify an amount of sub-picture clock ticks to wait after removal from the CPB of a preceding decoding unit in the access unit associated with the picture timing SEI message before removing from the CPB a current decoding unit in the access unit associated with the picture timing SEI message.

The decoding unit CPB removal delay parameters may specify an amount of sub-picture clock ticks to wait after removal from the CPB of the last decoding unit before removing from the CPB an i-th decoding unit in the access unit associated with the picture timing SEI message.

The electronic device may calculate the decoding unit CPB removal delay parameters according to a remainder of a modulo 2^{(cpb}^{_{—}}^{removal}^{_{—}}^{delay}^{_{—}}^{length}^{_{—}}^{minus1+1)} counter where cpb_removal_delay_length_minus1+1 is a length of a common decoding unit CPB removal delay parameter.

The electronic device may also generate, when the CPB supports operation on an access unit level, a picture timing SEI message including a CPB removal delay parameter that specifies how many clock ticks to wait after removal from the CPB of an access unit associated with a most recent buffering period SEI message in a preceding access unit before removing from the CPB the access unit data associated with the picture timing SEI message.

The electronic device may also determine whether the CPB supports operation on a sub-picture level or an access unit level. This may include determining a picture timing flag that indicates whether a Coded Picture Buffer (CPB) provides parameters supporting operation on a sub-picture level based on a value of the picture timing flag. The picture timing flag may be included in the picture timing SEI message.

Determining whether to include a common decoding unit CPB removal delay parameter may include setting a common decoding unit CPB removal delay flag to 1 when the common decoding unit CPB removal delay parameter is to be included in the picture timing SEI message. It may also include setting the common decoding unit CPB removal delay flag to 0 when the common decoding unit CPB removal delay parameter is not to be included in the picture timing SEI message. The common decoding unit CPB removal delay flag may be included in the picture timing SEI message.

The electronic device may also generate, when the CPB supports operation on a sub-picture level, separate network abstraction layer (NAL) units related parameters that indicate an amount, offset by one, of NAL units for each decoding unit in an access unit. Alternatively, or in addition to, the electronic device may generate a common NAL parameter that indicates an amount, offset by one, of NAL units common to each decoding unit in an access unit.

An electronic device for buffering a bitstream is also described. The electronic device includes a processor and instructions stored in memory that is in electronic communication with the processor. The electronic device determines that a CPB signals parameters on a sub-picture level for an access unit. The electronic device also determines, when a received picture timing Supplemental Enhancement Information (SEI) message comprises the common decoding unit Coded Picture Buffer (CPB) removal delay flag, a common decoding unit CPB removal delay parameter applicable to all decoding units in the access unit. The electronic device also determines, when the picture timing SEI message does not comprise the common decoding unit CPB removal delay flag, a separate decoding unit CPB removal delay parameter for each decoding unit in the access unit. The electronic device also removes decoding units from the CPB using the common decoding unit CPB removal delay parameter or the separate decoding unit CPB removal delay parameters. The electronic device also decodes the decoding units in the access unit.

A method for sending a message by an electronic device is also described. The method includes determining, when a Coded Picture Buffer (CPB) supports operation on a sub-picture level, whether to include a common decoding unit CPB removal delay parameter in a picture timing Supplemental Enhancement Information (SEI) message. The method also includes generating, when the common decoding unit CPB removal delay parameter is to be included in the picture timing SEI message, the common decoding unit CPB removal delay parameter, wherein the common decoding unit CPB removal delay parameter is applicable to all decoding units in an access unit from the CPB. The method also includes generating, when the common decoding unit CPB removal delay parameter is not to be included in the picture timing SEI message, a separate decoding unit CPB removal delay parameter for each decoding unit in the access unit. The method also includes sending the picture timing SEI message with the common decoding unit CPB removal delay parameter or the decoding unit CPB removal delay parameters.

A method for buffering a bitstream by an electronic device is also described. The method includes determining that a CPB signals parameters on a sub-picture level for an access unit. The method also includes determining, when a received picture timing Supplemental Enhancement Information (SEI) message comprises the common decoding unit Coded Picture Buffer (CPB) removal delay flag, a common decoding unit CPB removal delay parameter applicable to all decoding units in the access unit. The method also includes determining, when the picture timing SEI message does not comprise the common decoding unit CPB removal delay flag, a separate decoding unit CPB removal delay parameter for each decoding unit in the access unit. The method also includes removing decoding units from the CPB using the common decoding unit CPB removal delay parameter or the separate decoding unit CPB removal delay parameters. The method also includes decoding the decoding units in the access unit.

The systems and methods disclosed herein describe electronic devices for sending a message and buffering a bitstream. For example, the systems and methods disclosed herein describe buffering for bitstreams starting with sub-picture parameters. In some configurations, the systems and methods disclosed herein may describe signaling sub-picture based Hypothetical Reference Decoder (HRD) parameters. For instance, the systems and methods disclosed herein describe modification to a picture timing Supplemental Enhancement Information (SEI) message. The systems and methods disclosed herein (e.g., the HRD modification) may result in more compact signaling of parameters when each sub-picture arrives and is removed from CPB at regular intervals.

Furthermore, when the sub-picture level CPB removal delay parameters are present, the Coded Picture Buffer (CPB) may operate at access unit level or sub-picture level. The present systems and methods may also impose a bitstream constraint so that the sub-picture level based CPB operation and the access unit level CPB operation result in the same timing of decoding unit removal. Specifically the timing of removal of last decoding unit in an access unit when operating in sub-picture mode and the timing of removal of access unit when operating in access unit mode will be the same.

It should be noted that although the term “hypothetical” is used in reference to an HRD, the HRD may be physically implemented. For example, “HRD” may be used to describe an implementation of an actual decoder. In some configurations, an HRD may be implemented in order to determine whether a bitstream conforms to High Efficiency Video Coding (HEVC) specifications. For instance, an HRD may be used to determine whether Type I bitstreams and Type II bitstreams conform to HEVC specifications. A Type I bitstream may contain only Video Coding Layer (VCL) Network Access Layer (NAL) units and filler data NAL units. A Type II bitstream may contain additional other NAL units and syntax elements.

Joint Collaborative Team on Video Coding (JCTVC) document JCTVC-I0333 includes sub-picture based HRD and supports picture timing SEI messages. This functionality has been incorporated into the High Efficiency Video Coding (HEVC) Committee Draft (JCTVC-I1003), incorporated by reference herein in its entirety. B. Bross, W-J. Han, J-R. Ohm, G. J. Sullivan, Wang, and T-. Wiegand, “High efficiency video coding (HEVC) text specification draft 10 (for DFIS & Last Call),” JCTVC-J1003_v34, Geneva, January 2013 is hereby incorporated by reference herein in its entirety. B. Bros, W-J. Han, J-R. Ohm, G. J. Sullivan, Wang, and T-. Wiegand, “High efficiency video coding (HEVC) text specification draft 10,” JCTVC-L1003, Geneva, January 2013 is hereby incorporated by reference herein in its entirety. Chen, et al., “SHVC Draft 3,” JCTVC-N1008, Vienna, August 2013, is hereby incorporated by reference herein in its entirety. Tech, et al., “MV-HEVC Draft Text 5,” JCT3V-E1004, Vienna, August 2013, is hereby incorporated by reference herein in its entirety.

Examples regarding picture timing SEI message semantics in accordance with the systems and methods disclosed herein are given as follows. In particular, additional detail regarding the semantics of the modified syntax elements are given as follows.

The syntax of the picture timing SEI message is dependent on the content of the sequence parameter set that is active for the coded picture associated with the picture timing SEI message. However, unless the picture timing SEI message of an Instantaneous Decoding Refresh (IDR) access unit is preceded by a buffering period SEI message within the same access unit, the activation of the associated sequence parameter set (and, for IDR pictures that are not the first picture in the bitstream, the determination that the coded picture is an IDR picture) does not occur until the decoding of the first coded slice Network Abstraction Layer (NAL) unit of the coded picture. Since the coded slice NAL unit of the coded picture follows the picture timing SEI message in NAL unit order, there may be cases in which it is necessary for a decoder to store the raw byte sequence payload (RBSP) containing the picture timing SEI message until determining the parameters of the sequence parameter that will be active for the coded picture, and then perform the parsing of the picture timing SEI message.

As illustrated by the foregoing, the systems and methods disclosed herein provide syntax and semantics that modify a picture timing SEI message bitstreams carrying sub-picture based parameters. In some configurations, the systems and methods disclosed herein may be applied to HEVC specifications.

For convenience, several definitions are given as follows, which may be applied to the systems and methods disclosed herein. A random access point may be any point in a stream of data (e.g., bitstream) where decoding of the bitstream does not require access to any point in a bitstream preceding the random access point to decode a current picture and all pictures subsequent to said current picture in output order.

A buffering period may be specified as a set of access units between two instances of the buffering period SEI message in decoding order. Supplemental Enhancement Information (SEI) may contain information that is not necessary to decode the samples of coded pictures from VCL NAL units. SEI messages may assist in procedures related to decoding, display or other purposes. Conforming decoders may not be required to process this information for output order conformance to HEVC specifications (Annex C of HEVC specifications (JCTVC-L1003) includes specifications for conformance, for example). Some SEI message information may be used to check bitstream conformance and for output timing decoder conformance.

A buffering period SEI message may be an SEI message related to buffering period. A picture timing SEI message may be an SEI message related to CPB removal timing. These messages may define syntax and semantics which define bitstream arrival timing and coded picture removal timing.

A Coded Picture Buffer (CPB) may be a first-in first-out buffer containing access units in decoding order specified in a hypothetical reference decoder (HRD). An access unit may be a set of Network Access Layer (NAL) units that are consecutive in decoding order and contain exactly one coded picture. In addition to the coded slice NAL units of the coded picture, the access unit may also contain other NAL units not containing slices of the coded picture. The decoding of an access unit always results in a decoded picture. A NAL unit may be a syntax structure containing an indication of the type of data to follow and bytes containing that data in the form of a raw byte sequence payload interspersed as necessary with emulation prevention bytes.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

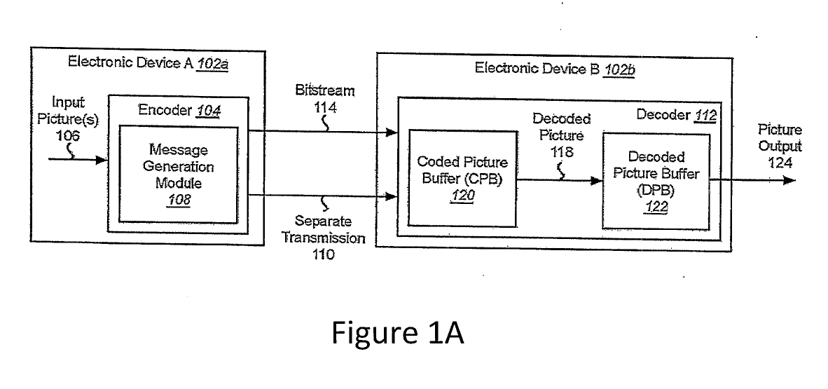

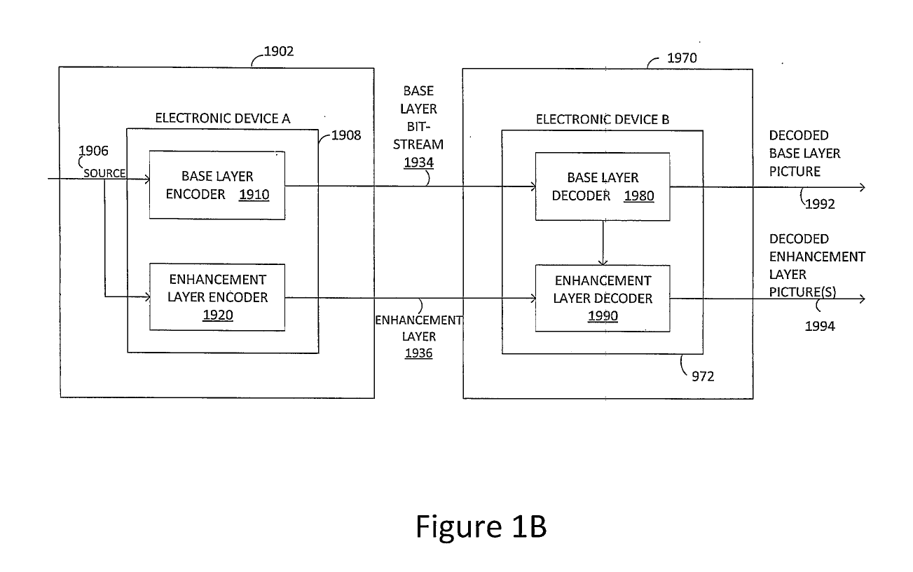

FIG. 1A is a block diagram illustrating an example of one or more electronic devices 102 in which systems and methods for sending a message and buffering a bitstream may be implemented. In this example, electronic device A 102a and electronic device B 102b are illustrated. However, it should be noted that one or more of the features and functionality described in relation to electronic device A 102a and electronic device B 102b may be combined into a single electronic device in some configurations.

Electronic device A 102a includes an encoder 104. The encoder 104 includes a message generation module 108. Each of the elements included within electronic device A 102a (e.g., the encoder 104 and the message generation module 108) may be implemented in hardware, software or a combination of both.

Electronic device A 102a may obtain one or more input pictures 106. In some configurations, the input picture(s) 106 may be captured on electronic device A 102a using an image sensor, may be retrieved from memory and/or may be received from another electronic device.

The encoder 104 may encode the input picture(s) 106 to produce encoded data. For example, the encoder 104 may encode a series of input pictures 106 (e.g., video). In one configuration, the encoder 104 may be a HEVC encoder. The encoded data may be digital data (e.g., part of a bitstream 114). The encoder 104 may generate overhead signaling based on the input signal.

The message generation module 108 may generate one or more messages. For example, the message generation module 108 may generate one or more SEI messages or other messages. For a CPB that supports operation on a sub-picture level, the electronic device 102 may send sub-picture parameters, (e.g., CPB removal delay parameter). Specifically, the electronic device 102 (e.g., the encoder 104) may determine whether to include a common decoding unit CPB removal delay parameter in a picture timing SEI message.

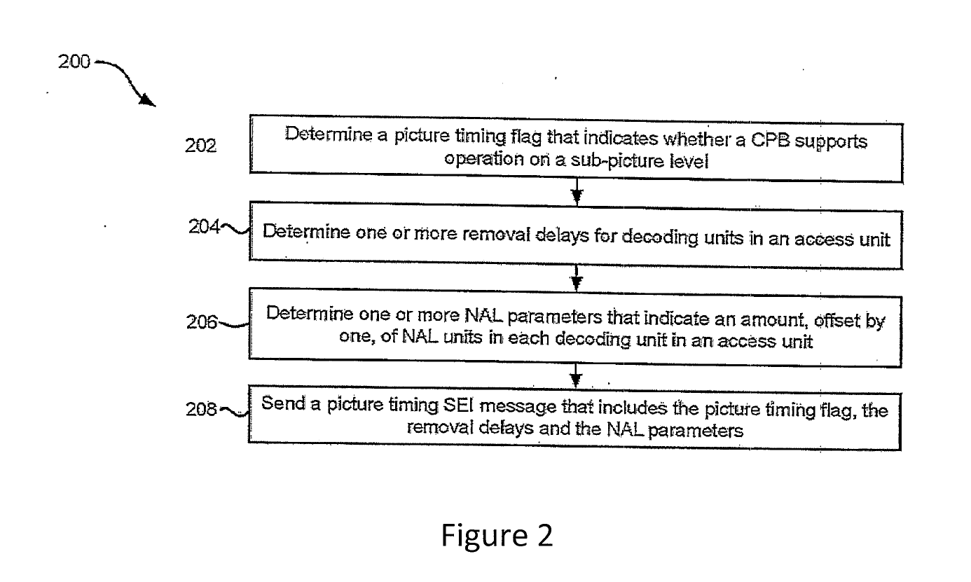

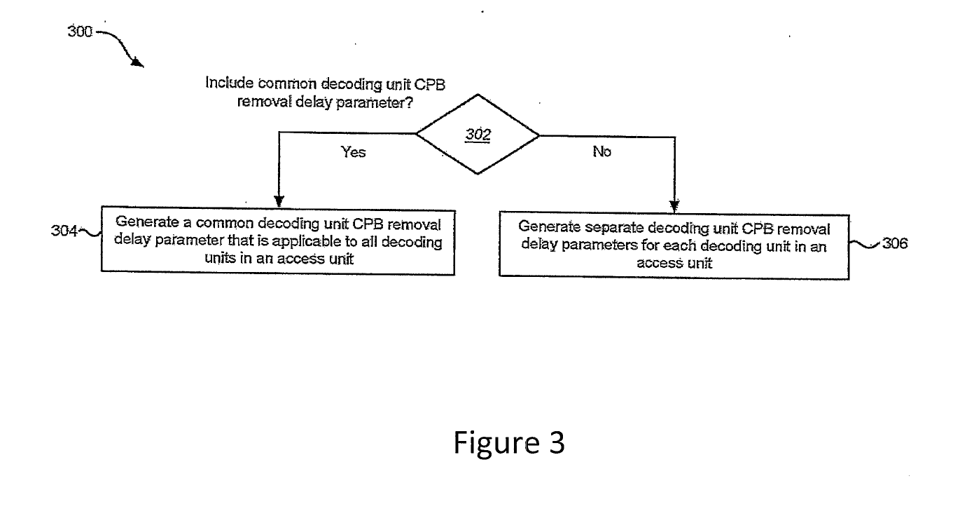

In contrast, when the common decoding unit CPB removal delay parameter is not to be included in the picture timing SEI message, the electronic device 102 may generate a separate decoding unit CPB removal delay for each decoding unit in the access unit with which the picture timing SEI message is associated. A message generation module 108 may perform one or more of the procedures described in connection with FIG. 2 and FIG. 3 below.

In some configurations, electronic device A 102a may send the message to electronic device B 102b as part of the bitstream 114. In some configurations electronic device A 102a may send the message to electronic device B 102b by a separate transmission 110. For example, the separate transmission may not be part of the bitstream 114. For instance, a picture timing SEI message or other message may be sent using some out-of-band mechanism. It should be noted that, in some configurations, the other message may include one or more of the features of a picture timing SEI message described above. Furthermore, the other message, in one or more aspects, may be utilized similarly to the SEI message described above.

The encoder 104 (and message generation module 108, for example) may produce a bitstream 114. The bitstream 114 may include encoded picture data based on the input picture(s) 106. In some configurations, the bitstream 114 may also include overhead data, such as a picture timing SEI message or other message, slice header(s), picture parameter set(s), etc. As additional input pictures 106 are encoded, the bitstream 114 may include one or more encoded pictures. For instance, the bitstream 114 may include one or more encoded pictures with corresponding overhead data (e.g., a picture timing SEI message or other message).

The bitstream 114 may be provided to a decoder 112. In one example, the bitstream 114 may be transmitted to electronic device B 102b using a wired or wireless link. In some cases, this may be done over a network, such as the Internet or a Local Area Network (LAN). As illustrated in FIG. 1A, the decoder 112 may be implemented on electronic device B 102b separately from the encoder 104 on electronic device A 102a. However, it should be noted that the encoder 104 and decoder 112 may be implemented on the same electronic device in some configurations. In an implementation where the encoder 104 and decoder 112 are implemented on the same electronic device, for instance, the bitstream 114 may be provided over a bus to the decoder 112 or stored in memory for retrieval by the decoder 112.

The decoder 112 may be implemented in hardware, software or a combination of both. In one configuration, the decoder 112 may be a HEVC decoder. The decoder 112 may receive (e.g., obtain) the bitstream 114. The decoder 112 may generate one or more decoded pictures 118 based on the bitstream 114. The decoded picture(s) 118 may be displayed, played back, stored in memory and/or transmitted to another device, etc.

The decoder 112 may include a CPB 120. The CPB 120 may temporarily store encoded pictures. The CPB 120 may use parameters found in a picture timing SEI message to determine when to remove data. When the CPB 120 supports operation on a sub-picture level, individual decoding units may be removed rather than entire access units at one time. The decoder 112 may include a Decoded Picture Buffer (DPB) 122. Each decoded picture is placed in the DPB 122 for being referenced by the decoding process as well as for output and cropping. A decoded picture is removed from the DPB at the later of the DPB output time or the time that it becomes no longer needed for inter-prediction reference.

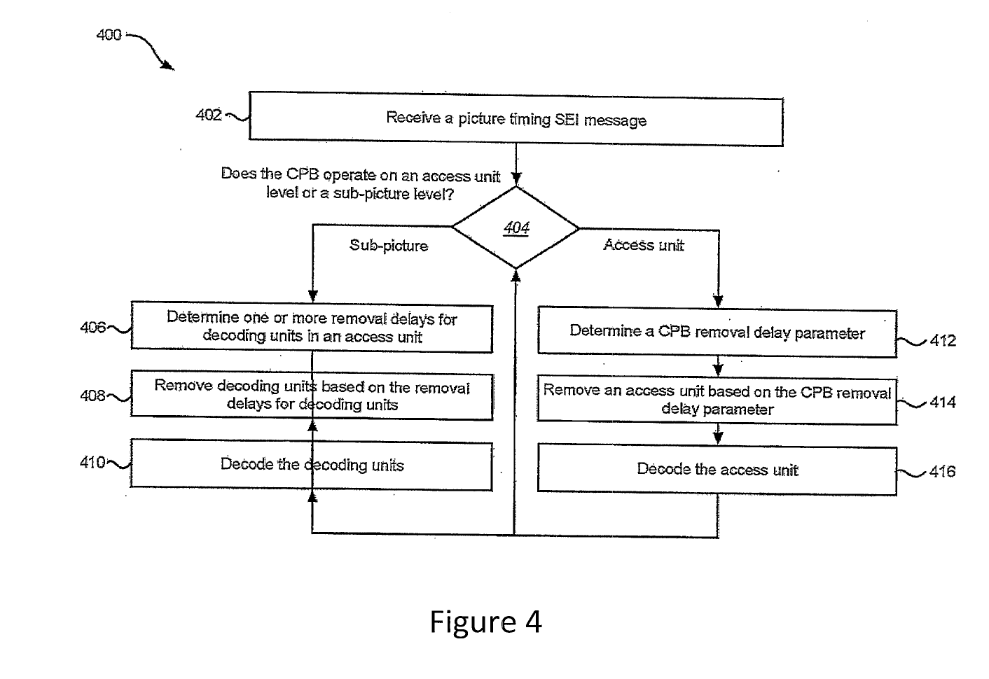

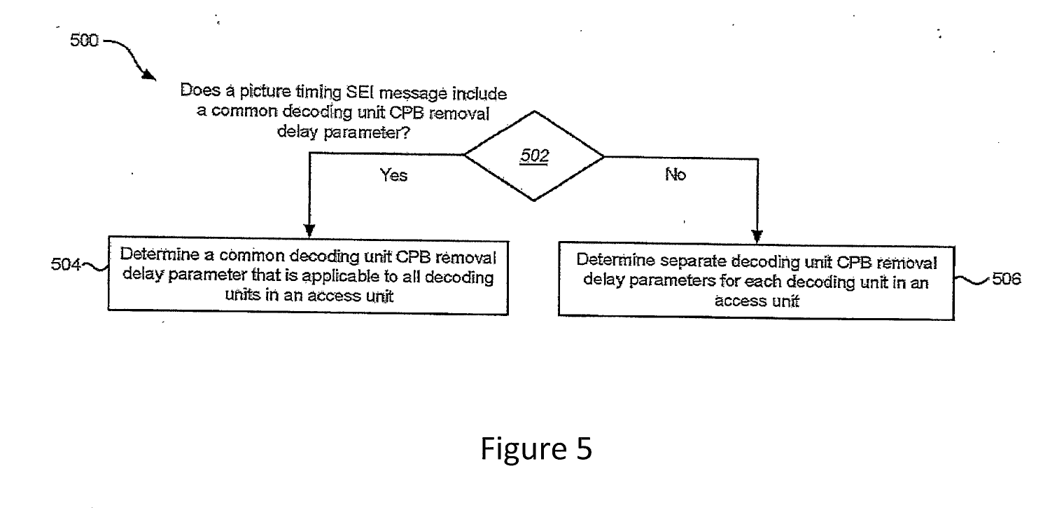

The decoder 112 may receive a message (e.g., picture timing SEI message or other message). The decoder 112 may also determine whether the received message includes a common decoding unit CPB removal delay parameter. This may include identifying a flag that is set when the common parameter is present in the picture timing SEI message. If the common parameter is present, the decoder 112 may determine the common decoding unit CPB removal delay parameter applicable to all decoding units in the access unit. If the common parameter is not present, the decoder 112 may determine a separate decoding unit CPB removal delay parameter for each decoding unit in the access unit. The decoder 112 may also remove decoding units from the CPB 120 using either the common decoding unit CPB removal delay parameter or the separate decoding unit CPB removal delay parameters. The CPB 120 may perform one or more of the procedures described in connection with FIG. 4 and FIG. 5 below.

The HRD described above may be one example of the decoder 112 illustrated in FIG. 1A. Thus, an electronic device 102 may operate in accordance with the HRD and CPB 120 and DPB 122 described above, in some configurations.

It should be noted that one or more of the elements or parts thereof included in the electronic device(s) 102 may be implemented in hardware. For example, one or more of these elements or parts thereof may be implemented as a chip, circuitry or hardware components, etc. It should also be noted that one or more of the functions or methods described herein may be implemented in and/or performed using hardware. For example, one or more of the methods described herein may be implemented in and/or realized using a chipset, an Application-Specific Integrated Circuit (ASIC), a Large-Scale Integrated circuit (LSI) or integrated circuit, etc.

FIG. 1B is a block diagram illustrating another example of an encoder 1908 and a decoder 1972. In this example, electronic device A 1902 and electronic device B 1970 are illustrated. However, it should be noted that the features and functionality described in relation to electronic device A 1902 and electronic device B 1970 may be combined into a single electronic device in some configurations.

Electronic device A 1902 includes the encoder 1908. The encoder 1908 may include a base layer encoder 1910 and an enhancement layer encoder 1920. The video encoder 1908 is suitable for scalable video coding and multi-view video coding, as described later. The encoder 1908 may be implemented in hardware, software or a combination of both. In one configuration, the encoder 1908 may be a high-efficiency video coding (HEVC) coder, including scalable and/or multi-view. Other coders may likewise be used. Electronic device A 1902 may obtain a source 1906. In some configurations, the source 1906 may be captured on electronic device A 1902 using an image sensor, retrieved from memory or received from another electronic device.

The encoder 1908 may code the source 1906 to produce a base layer bitstream 1934 and an enhancement layer bitstream 1936. For example, the encoder 1908 may code a series of pictures (e.g., video) in the source 1906. In particular, for scalable video encoding for SNR scalability also known as quality scalability the same source 1906 may be provided to the base layer and the enhancement layer encoder. In particular, for scalable video encoding for spatial scalability a downsampled source may be used for the base layer encoder. In particular, for multi-view encoding a different view source may be used for the base layer encoder and the enhancement layer encoder. The bitstreams 1934, 1936 may include coded picture data based on the source 1906. In some configurations, the bitstreams 1934, 1936 may also include overhead data, such as slice header information, picture parameter set (PPS) information, etc. As additional pictures in the source 1906 are coded, the bitstreams 1934, 1936 may include one or more coded pictures.

The bitstreams 1934, 1936 may be provided to the decoder 1972. The decoder 1972 may include a base layer decoder 1980 and an enhancement layer decoder 1990. The video decoder 1972 is suitable for scalable video decoding and multi-view video decoding. In one example, the bitstreams 1934, 1936 may be transmitted to electronic device B 1970 using a wired or wireless link. In some cases, this may be done over a network, such as the Internet or a Local Area Network (LAN). As illustrated in FIG. 1B, the decoder 1972 may be implemented on electronic device B 1970 separately from the encoder 1908 on electronic device A 1902. However, it should be noted that the encoder 1908 and decoder 1972 may be implemented on the same electronic device in some configurations. In an implementation where the encoder 1908 and decoder 1972 are implemented on the same electronic device, for instance, the bitstreams 1934, 1936 may be provided over a bus to the decoder 1972 or stored in memory for retrieval by the decoder 1972. The decoder 1972 may provide a decoded base layer 1992 and decoded enhancement layer picture(s) 1994 as output.

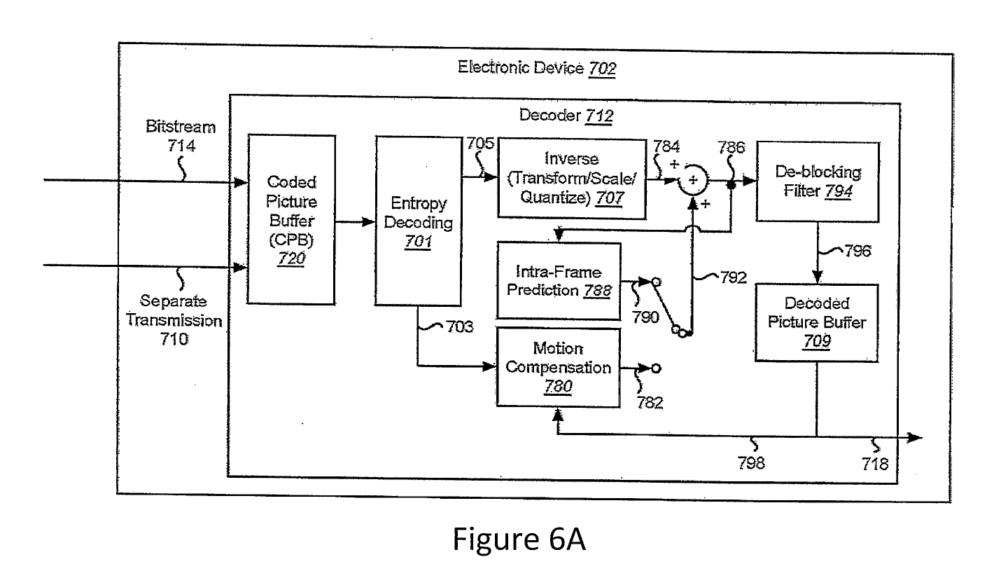

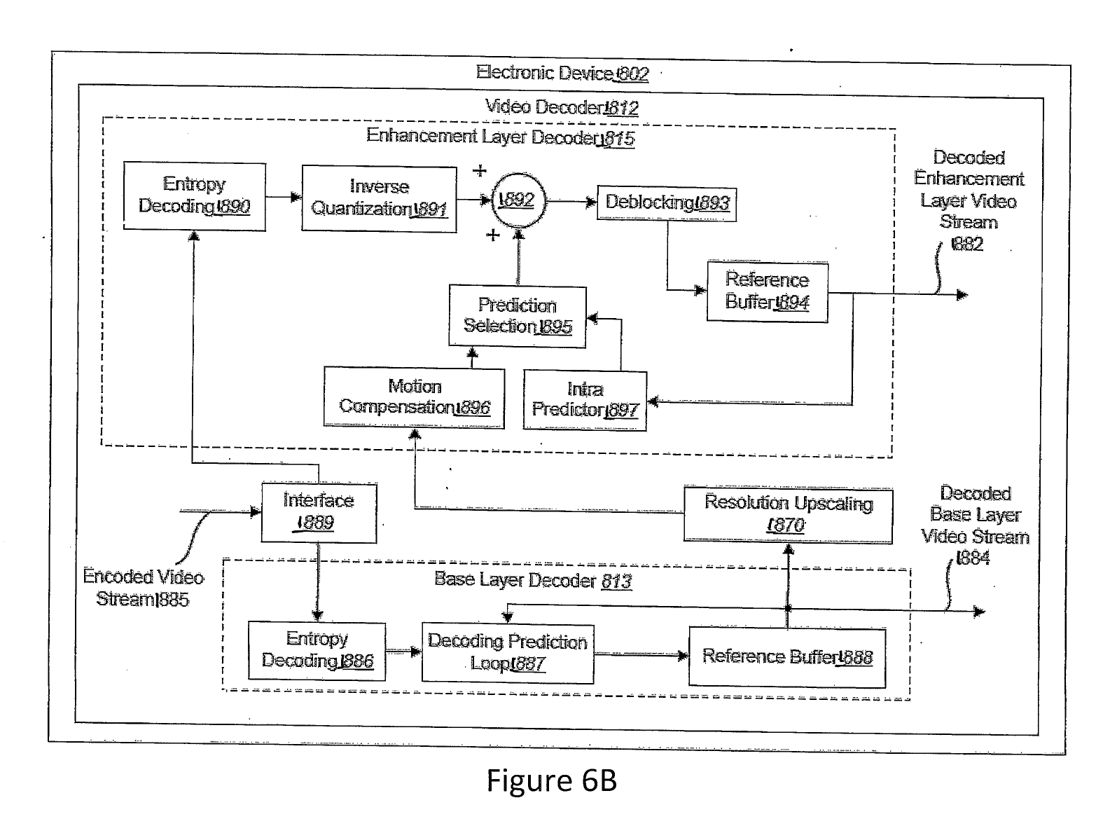

The decoder 1972 may be implemented in hardware, software or a combination of both. In one configuration, the decoder 1972 may be a high-efficiency video coding (HEVC) decoder, including scalable and/or multi-view. Other decoders may likewise be used. The decoder 1972 may be similar to the decoder 1812 described later in connection with FIG. 6B. Also, the base layer encoder and/or the enhancement layer encoder may each include a message generation module, such as that described in relation to FIG. 1A. Also, the base layer decoder and/or the enhancement layer decoder may include a coded picture buffer and/or a decoded picture buffer, such as that described in relation to FIG. 1A. In addition, the electronic devices of FIG. 1B may operate in accordance with the functions of the electronic devices of FIG. 1A, as applicable.

FIG. 2 is a flow diagram illustrating one configuration of a method 200 for sending a message. The method 200 may be performed by an encoder 104 or one of its sub-parts (e.g., a message generation module 108). The encoder 104 may determine 202 a picture timing flag that indicates whether a CPB 120 supports operation on a sub-picture level. For example, when the picture timing flag is set to 1, the CPB 120 may operate on an access unit level or a sub-picture level. It should be noted that even when the picture timing flag is set to 1, the decision about whether to actually operate at the sub-picture level is left to the decoder 112 itself.

The encoder 104 may also determine 204 one or more removal delays for decoding units in an access unit. For example, the encoder 104 may determine a single common decoding unit CPB removal delay parameter that is applicable to all decoding units in the access unit from the CPB 120. Alternatively, the encoder 104 may determine a separate decoding unit CPB removal delay for each decoding unit in the access unit.

The encoder 104 may also determine 206 one or more NAL parameters that indicate an amount, offset by one, of NAL units in each decoding unit in the access point. For example, the encoder 104 may determine a single common NAL parameter that is applicable to all decoding units in the access unit from the CPB 120. Alternatively, the encoder 104 may determine a separate decoding unit CPB removal delay for each decoding unit in the access unit.

The encoder 104 may also send 208 a picture timing SEI message that includes the picture timing flag, the removal delays and the NAL parameters. For example, the electronic device 102 may transmit the message via one or more of wireless transmission, wired transmission, device bus, network, etc. For instance, electronic device A 102a may transmit the message to electronic device B 102b. The message may be part of the bitstream 114, for example. In some configurations, electronic device A 102a may send 208 the message to electronic device B 102b in a separate transmission 110 (that is not part of the bitstream 114). For instance, the message may be sent using some out-of-band mechanism. In some case the information indicated in 204, 206 may be sent in a SEI message different than picture timing SEI message. In yet another case the information indicated in 204, 206 may be sent in a parameter set e.g. video parameter set and/or sequence parameter set and/or picture parameter set and/or adaptation parameter set and/or slice header.

FIG. 3 is a flow diagram illustrating one configuration of a method 300 for determining one or more removal delays for decoding units in an access unit. In other words, the method 300 illustrated in FIG. 3 may further illustrate step 204 in the method 200 illustrated in FIG. 2. The method 300 may be performed by an encoder 104. The encoder 104 may determine 302 whether to include a common decoding unit CPB removal delay parameter. This may include determining whether a common decoding unit CPB removal delay flag is set. An encoder 104 may send this common parameter in case the decoding units are removed from the CPB at regular interval. This may be the case, for example, when each decoding unit corresponds to certain number of rows of the picture or has some other regular structure.

For example, the common decoding unit CPB removal delay flag may be set to 1 when the common decoding unit CPB removal delay parameter is to be included in the picture timing SEI message and 0 when it is not to be included. If yes (e.g., flag is set to 1), the encoder 104 may determine 304 a common decoding unit CPB removal delay parameter (e.g., common_du_cpb_removal_delay) that is applicable to all decoding units in an access unit. If no (e.g., flag is set to 0), the encoder 104 may determine 306 separate decoding unit CPB removal delay parameters for each decoding unit in an access unit.

If a common decoding unit CPB removal delay parameter is present in a picture timing SEI message, it may specify an amount of sub-picture clock ticks to wait after removal from the CPB 120 of an immediately preceding decoding unit before removing from the CPB 120 a current decoding unit in the access unit associated with the picture timing SEI message.

For example, when a decoding unit is a first decoding unit in an access unit, the common decoding unit CPB 120 removal delay parameter may specify an amount of sub-picture clock ticks to wait after removal from the CPB 120 of a last decoding unit in an access unit associated with a most recent buffering period SEI message in a preceding access unit before removing from the CPB 120 the first decoding unit in the access unit associated with the picture timing SEI message.

When the decoding unit is a non-first decoding unit in an access unit, the common decoding unit CPB removal delay parameter may specify an amount of sub-picture clock ticks to wait after removal from the CPB 120 of a preceding decoding unit in the access unit associated with the picture timing SEI message before removing from the CPB a current decoding unit in the access unit associated with the picture timing SEI message.

In contrast, when a common decoding unit CPB removal delay parameter is not sent in a picture timing SEI message, separate decoding unit CPB removal delay parameters may be included in the picture timing SEI message for each decoding unit in an access unit. The decoding unit CPB removal delay parameters may specify an amount of sub-picture clock ticks to wait after removal from the CPB 120 of the last decoding unit before removing from the CPB 120 an i-th decoding unit in the access unit associated with the picture timing SEI message. The decoding unit CPB removal delay parameters may be calculated according to a remainder of a modulo 2^{(cpb}^{_{—}}^{removal}^{_{—}}^{delay}^{_{—}}^{length}^{_{—}}^{minus1+1)} counter where cpb_removal_delay_length_minus1+1 is a length of a common decoding unit CPB removal delay parameter.

FIG. 4 is a flow diagram illustrating one configuration of a method 400 for buffering a bitstream. The method 400 may be performed by a decoder 112 in an electronic device 102 (e.g., electronic device B 102b), which may receive 402 a message (e.g., a picture timing SEI message or other message). For example, the electronic device 102 may receive 402 the message via one or more of wireless transmission, wired transmission, device bus, network, etc. For instance, electronic device B 102b may receive 402 the message from electronic device A 102a. The message may be part of the bitstream 114, for example. In another example, electronic device B 102b may receive the message from electronic device A 102a in a separate transmission 110 (that is not part of the bitstream 114, for example). For instance, the picture timing SEI message may be received using some out-of-band mechanism. In some configurations, the message may include one or more of a picture timing flag, one or more removal delays for decoding units in an access unit and one or more NAL parameters. Thus, receiving 402 the message may include receiving one or more of a picture timing flag, one or more removal delays for decoding units in an access unit and one or more NAL parameters.

The decoder 112 may determine 404 whether a CPB 120 operates on an access unit level or a sub-picture level. For example, a decoder 112 may decide to operate on sub-picture basis if it wants to achieve low latency. Alternatively, the decision may be based on whether the decoder 112 has enough resources to support sub-picture based operation. If the CPB 120 operates on a sub-picture level, the decoder may determine 406 one or more removal delays for decoding units in an access unit.

The decoder 112 may also remove 408 decoding units based on the removal delays for the decoding units, i.e., using either a common parameter applicable to all decoding units in an access unit or separate parameters for every decoding unit. The decoder 112 may also decode 410 the decoding units.

If the CPB operates on an access unit level, the decoder 112 may determine 412 a CPB removal delay parameter. This may be included in the received picture timing SEI message. The decoder 112 may also remove 414 an access unit based on the CPB removal delay parameter and decode 416 the access unit. In other words, the decoder 112 may decode whole access units at a time, rather than decoding units within the access unit.

FIG. 5 is a flow diagram illustrating one configuration of a method 500 for determining one or more removal delays for decoding units in an access unit. In other words, the method 500 illustrated in FIG. 5 may further illustrate step 406 in the method 400 illustrated in FIG. 4. The method 500 may be performed by a decoder 112. The decoder 112 may determine 502 whether a received picture timing SEI message includes a common decoding unit CPB removal delay parameter. This may include determining whether a common decoding unit CPB removal delay flag is set. If yes, the decoder 112 may determine 504 a common decoding unit CPB removal delay parameter that is applicable to all decoding units in an access unit. If no, the decoder 112 may determine 506 separate decoding unit CPB removal delay parameters for each decoding unit in an access unit.

FIG. 6A is a block diagram illustrating one configuration of a decoder 712 on an electronic device 702. The decoder 712 may be included in an electronic device 702. For example, the decoder 712 may be a HEVC decoder. The decoder 712 and one or more of the elements illustrated as included in the decoder 712 may be implemented in hardware, software or a combination of both. The decoder 712 may receive a bitstream 714 (e.g., one or more encoded pictures and overhead data included in the bitstream 714) for decoding. In some configurations, the received bitstream 714 may include received overhead data, such as a message (e.g., picture timing SEI message or other message), slice header, PPS, etc. In some configurations, the decoder 712 may additionally receive a separate transmission 710. The separate transmission 710 may include a message (e.g., a picture timing SEI message or other message). For example, a picture timing SEI message or other message may be received in a separate transmission 710 instead of in the bitstream 714. However, it should be noted that the separate transmission 710 may be optional and may not be utilized in some configurations.

The decoder 712 includes a CPB 720. The CPB 720 may be configured similarly to the CPB 120 described in connection with FIG. 1 above. Additionally or alternatively, the decoder 712 may perform one or more of the procedures described in connection with FIG. 4 and FIG. 5. For example, the decoder 712 may receive a message (e.g., picture timing SEI message or other message) with sub-picture parameters and remove and decode decoding units in an access unit based on the sub-picture parameters. It should be noted that one or more access units may be included in the bitstream and may include one or more of encoded picture data and overhead data.

The Coded Picture Buffer (CPB) 720 may provide encoded picture data to an entropy decoding module 701. The encoded picture data may be entropy decoded by an entropy decoding module 701, thereby producing a motion information signal 703 and quantized, scaled and/or transformed coefficients 705.

The motion information signal 703 may be combined with a portion of a reference frame signal 798 from a decoded picture buffer 709 at a motion compensation module 780, which may produce an inter-frame prediction signal 782. The quantized, descaled and/or transformed coefficients 705 may be inverse quantized, scaled and inverse transformed by an inverse module 707, thereby producing a decoded residual signal 784. The decoded residual signal 784 may be added to a prediction signal 792 to produce a combined signal 786. The prediction signal 792 may be a signal selected from either the inter-frame prediction signal 782 produced by the motion compensation module 780 or an intra-frame prediction signal 790 produced by an intra-frame prediction module 788. In some configurations, this signal selection may be based on (e.g., controlled by) the bitstream 714.

The intra-frame prediction signal 790 may be predicted from previously decoded information from the combined signal 786 (in the current frame, for example). The combined signal 786 may also be filtered by a de-blocking filter 794. The resulting filtered signal 796 may be written to decoded picture buffer 709. The resulting filtered signal 796 may include a decoded picture. The decoded picture buffer 709 may provide a decoded picture which may be outputted 718. In some cases 709 may be a considered as frame memory.

FIG. 6B is a block diagram illustrating one configuration of a video decoder 1812 on an electronic device 1802. The video decoder 1812 may include an enhancement layer decoder 1815 and a base layer decoder 1813. The video decoder 812 may also include an interface 1889 and resolution upscaling 1870. The video decoder of FIG. 6B, for example, is suitable for scalable video coding and multi-view video encoded, as described herein.

The interface 1889 may receive an encoded video stream 1885. The encoded video stream 1885 may consist of base layer encoded video stream and enhancement layer encoded video stream. These two streams may be sent separately or together. The interface 1889 may provide some or all of the encoded video stream 1885 to an entropy decoding block 1886 in the base layer decoder 1813. The output of the entropy decoding block 1886 may be provided to a decoding prediction loop 1887. The output of the decoding prediction loop 1887 may be provided to a reference buffer 1888. The reference buffer may provide feedback to the decoding prediction loop 1887. The reference buffer 1888 may also output the decoded base layer video stream 1884.

The interface 1889 may also provide some or all of the encoded video stream 1885 to an entropy decoding block 1890 in the enhancement layer decoder 1815. The output of the entropy decoding block 1890 may be provided to an inverse quantization block 1891. The output of the inverse quantization block 1891 may be provided to an adder 1892. The adder 1892 may add the output of the inverse quantization block 1891 and the output of a prediction selection block 1895. The output of the adder 1892 may be provided to a deblocking block 1893. The output of the deblocking block 1893 may be provided to a reference buffer 1894. The reference buffer 1894 may output the decoded enhancement layer video stream 1882. The output of the reference buffer 1894 may also be provided to an intra predictor 1897. The enhancement layer decoder 1815 may include motion compensation 1896. The motion compensation 1896 may be performed after the resolution upscaling 1870. The prediction selection block 1895 may receive the output of the intra predictor 1897 and the output of the motion compensation 1896. Also, the decoder may include one or more coded picture buffers, as desired, such as together with the interface 1889.

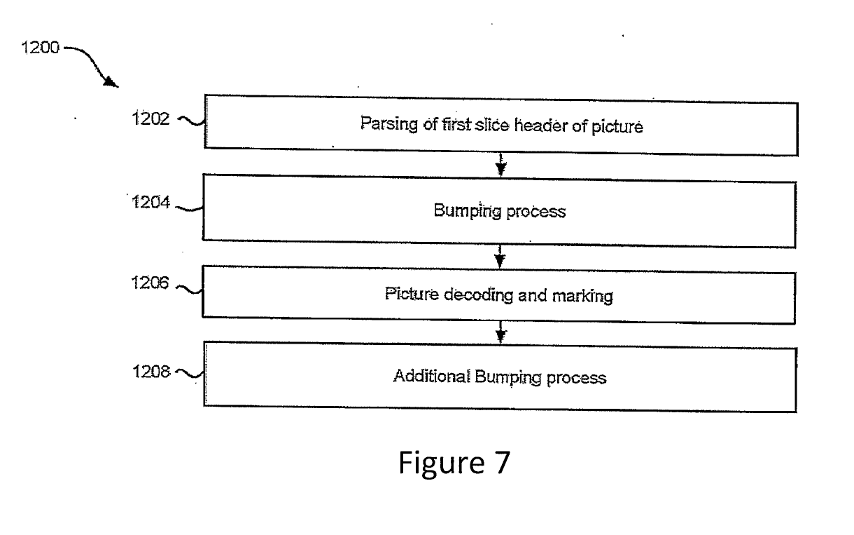

FIG. 7 is a flow diagram illustrating one configuration of a method 1200 for operation of decoded picture buffer (DPB). The method 1200 may be performed by an encoder 104 or one of its sub-parts (e.g., a decoded picture buffer module 676). The method 1200 may be performed by a decoder 112 in an electronic device 102 (e.g., electronic device B 102b). Additionally or alternatively the method 1200 may be performed by a decoder 712 or one of its sub-parts (e.g., a decoded picture buffer module 709). The decoder may parse first slice header of a picture 1202. The output and removal of pictures from DPB before decoding of the current picture (but after parsing the slice header of the first slice of the current picture) happens instantaneously when first decoding unit of the access unit containing the current picture is removed from the CPB.

The decoding process for reference picture set (RPS) is invoked. Reference picture set is a set of reference pictures associated with a picture, consisting of all reference pictures that are prior to the associated picture in decoding order, that may be used for inter prediction of the associated picture or any picture following the associated picture in decoding order.

The bitstream of the video may include a syntax structure that is placed into logical data packets generally referred to as Network Abstraction Layer (NAL) units. Each NAL unit includes a NAL unit header, such as a two-byte NAL unit header (e.g., 16 bits), to identify the purpose of the associated data payload. For example, each coded slice (and/or picture) may be coded in one or more slice (and/or picture) NAL units. Other NAL units may be included for other categories of data, such as for example, supplemental enhancement information, coded slice of temporal sub-layer access (TSA) picture, coded slice of step-wise temporal sub-layer access (STSA) picture, coded slice a non-TSA, non-STSA trailing picture, coded slice of broken link access picture, coded slice of instantaneous decoded refresh picture, coded slice of clean random access picture, coded slice of decodable leading picture, coded slice of tagged for discard picture, video parameter set, sequence parameter set, picture parameter set, access unit delimiter, end of sequence, end of bitstream, filler data, and/or sequence enhancement information message. Table (4) illustrates one example of NAL unit codes and NAL unit type classes. Other NAL unit types may be included, as desired. It should also be understood that the NAL unit type values for the NAL units shown in the Table (4) may be reshuffled and reassigned. Also additional NAL unit types may be added. Also some NAL unit types may be removed.

An intra random access point (IRAP) picture is a coded picture for which each video coding layer NAL unit has nal_unit_type in the range of BLA_W_LP to RSV_IRAP_VCL23, inclusive as shown in Table (4). An IRAP picture contains only Intra coded (I) slices. An instantaneous decoding refresh (IDR) picture is an IRAP picture for which each video coding layer NAL unit has nal_unit_type equal to IDR_W_RADL or IDR_N_LP as shown in Table (4). An instantaneous decoding refresh (IDR) picture contains only I slices, and may be the first picture in the bitstream in decoding order, or may appear later in the bitstream. Each IDR picture is the first picture of a coded video sequence (CVS) in decoding order. A broken link access (BLA) picture is an IRAP picture for which each video coding layer NAL unit has nal_unit_type equal to BLA_W_LP, BLA_W_RADL, or BLA_N_LP as shown in Table (4). A BLA picture contains only I slices, and may be the first picture in the bitstream in decoding order, or may appear later in the bitstream. Each BLA picture begins a new coded video sequence, and has the same effect on the decoding process as an IDR picture. However, a BLA picture contains syntax elements that specify a non-empty reference picture set.

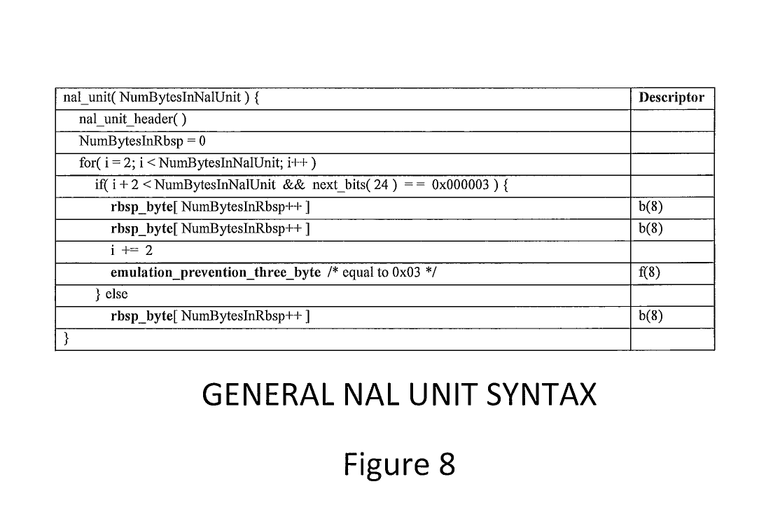

Referring to FIG. 8, a general NAL unit syntax structure is illustrated. The NAL unit header two byte syntax shown in Table (5) is included in the reference to nal_unit_header( ) of FIG. 8. The remainder of the NAL unit syntax primarily relates to the RBSP.

TABLE (4)

| | Name of | Content of NAL unit and RBSP syntax | NAL unit |
|---|---|---|---|
| nal_unit_type | nal_unit_type | structure | type class |
| 0 | TRAIL_N | Coded slice segment of a non-TSA, non- | VCL |
| 1 | TRAIL_R | STSA trailing picture | |
| | | slice_segment_layer_rbsp( ) | |
| 2 | TSA_N | Coded slice segment of a TSA picture | VCL |
| 3 | TSA_R | slice_segment_layer_rbsp( ) | |
| 4 | STSA_N | Coded slice segment of an STSA picture | VCL |
| 5 | STSA_R | slice_segment_layer_rbsp( ) | |
| 6 | RADL_N | Coded slice segment of a RADL picture | VCL |
| 7 | RADL_R | slice_segment_layer_rbsp( ) | |
| 8 | RASL_N | Coded slice segment of a RASL picture | VCL |
| 9 | RASL_R | slice_segment_layer_rbsp( ) | |
| 10 | RSV_VCL_N10 | Reserved non-IRAP sub-layer non-reference | VCL |
| 12 | RSV_VCL_N12 | VCL NAL unit types | |
| 14 | RSV_VCL_N14 | | |
| 11 | RSV_VCL_R11 | Reserved non-IRAP sub-layer reference VCL | VCL |
| 13 | RSV_VCL_R13 | NAL unit types | |
| 15 | RSV_VCL_R15 | | |
| 16 | BLA_W_LP | Coded slice segment of a BLA picture | VCL |
| 17 | BLA_W_RADL | slice_segment_layer_rbsp( ) | |
| 18 | BLA_N_LP | | |
| 19 | IDR_W_RADL | Coded slice segment of an IDR picture | VCL |
| 20 | IDR_N_LP | slice_segment_layer_rbsp( ) | |
| 21 | CRA_NUT | Coded slice segment of a CRA picture | VCL |
| | | slice_segment_layer_rbsp( ) | |
| 22 | RSV_IRAP_VCL22 | Reserved IRAP VCL NAL unit types | VCL |
| 23 | RSV_IRAP_VCL23 | | |
| 24 . . . 31 | RSV_VCL24 . . . | Reserved non-IRAP VCL NAL unit types | VCL |
| | RSV_VCL31 | | |
| 32 | VPS_NUT | Video parameter set | non-VCL |
| | | video_parameter_set_rbsp( ) | |
| 33 | SPS_NUT | Sequence parameter set | non-VCL |
| | | seq_parameter_set_rbsp( ) | |
| 34 | PPS_NUT | Picture parameter set | non-VCL |
| | | pic_parameter_set_rbsp( ) | |
| 35 | AUD_NUT | Access unit delimiter | non-VCL |
| | | access_unit_delimiter_rbsp( ) | |
| 36 | EOS_NUT | End of sequence | non-VCL |
| | | end_of_seq_rbsp( ) | |
| 37 | EOB_NUT | End of bitstream | non-VCL |
| | | end_of_bitstream_rbsp( ) | |
| 38 | FD_NUT | Filler data | non-VCL |
| | | filler_data_rbsp( ) | |
| 39 | PREFIX_SEI_NUT | Supplemental enhancement information | non-VCL |
| 40 | SUFFIX_SEI_NUT | sei_rbsp( ) | |
| 41 . . . 47 | RSV_NVCL41 . . . | Reserved | non-VCL |
| | RSV_NVCL47 | | |
| 48 . . . 63 | UNSPEC48 . . . | Unspecified | non-VCL |
| | UNSPEC63 | | |

Referring to Table (5), the NAL unit header syntax may include two bytes of data, namely, 16 bits. The first bit is a “forbidden_zero_bit” which is always set to zero at the start of a NAL unit. The next six bits is a “nal_unit_type” which specifies the type of raw byte sequence payloads (“RBSP”) data structure contained in the NAL unit as shown in Table (4). The next 6 bits is a “nuh_layer_id” which specify the identifier of the layer. In some cases these six bits may be specified as “nuh_reserved_zero_{—}6 bits” instead. The nuh_reserved_zero_{—}6 bits may be equal to 0 in the base specification of the standard. In a scalable video coding and/or syntax extensions nuh_layer_id may specify that this particular NAL unit belongs to the layer identified by the value of these 6 bits. The next syntax element is “nuh_temporal_id_plus1”. The nuh_temporal_id_plus1 minus 1 may specify a temporal identifier for the NAL unit. The variable temporal identifier TemporalId may be specified as TemporalId=nuh_temporal_id_plus1−1. The temporal identifier TemporalId is used to identify a temporal sub-layer. The variable HighestTid identifies the highest temporal sub-layer to be decoded.

TABLE (5)

De-
scrip-
tor

nal_unit_header( ) {

| | |
|---|---|
| forbidden_zero_bit | f(1) |
| nal_unit_type | u(6) |
| nuh_layer_id | u(6) |
| nuh_temporal_id_plus1 | u(3) |

}

Table (6) shows an exemplary sequence parameter set (SPS) syntax structure.

pic_width_in_luma_samples specifies the width of each decoded picture in units of luma samples. pic_width_in_luma_samples shall not be equal to 0.

pic_height_in_luma_samples specifies the height of each decoded picture in units of luma samples. pic_height_in_luma_samples shall not be equal to 0.

sps_max_sub_layers_minus1 plus 1 specifies the maximum number of temporal sub-layers that may be present in each CVS referring to the SPS. The value of sps_max_sub_layers_minus1 shall be in the range of 0 to 6, inclusive.

sps_sub_layer_ordering_info_present_flag flag equal to 1 specifies that sps_max_dec_pic_buffering_minus1[i], sps_max_num_reorder_pics[i], and sps_max_latency_increase_plus1[i] syntax elements are present for sps_max_sub_layers_minus1+1 sub-layers. sps_sub_layer_ordering_info_present_flag equal to 0 specifies that the values of sps_max_dec_pic_buffering_minus1 [sps_max_sub_layers_minus1], sps_max_num_reorder_pics[sps_max_sub_layers_minus1], and sps_max_latency_increase_plus1 [sps_max_sub_layers_minus1] apply to all sub-layers.

sps_max_dec_pic_buffering_minus1[i] plus 1 specifies the maximum required size of the decoded picture buffer for the CVS in units of picture storage buffers when HighestTid is equal to i. The value of sps_max_dec_pic_buffering_minus1[i] shall be in the range of 0 to MaxDpbSize−1, inclusive where MaxDpbSize specifies the maximum decoded picture buffer size in units of picture storage buffers. When i is greater than 0, sps_max_dec_pic_buffering_minus1[i] shall be greater than or equal to sps_max_dec_pic_buffering_minus1[i−1]. When sps_max_dec_pic_buffering_minus1[i] is not present for i in the range of 0 to sps_max_sub_layers_minus1−1, inclusive, due to sps_sub_layer_ordering_info_present_flag being equal to 0, it is inferred to be equal to sps_max_dec_pic_buffering_minus1[sps_max_sub_layers_minus1].

sps_max_num_reorder_pics[i] indicates the maximum allowed number of pictures that can precede any picture in the CVS in decoding order and follow that picture in output order when HighestTid is equal to i. The value of sps_max_num_reorder_pics[i] shall be in the range of 0 to sps_max_dec_pic_buffering_minus1[i], inclusive. When i is greater than 0, sps_max_num_reorder_pics[i] shall be greater than or equal to sps_max_num_reorder_pics[i−1]. When sps_max_num_reorder_pics[i] is not present for i in the range of 0 to sps_max_sub_layers_minus1−1, inclusive, due to sps_sub_layer_ordering_info_present_flag being equal to 0, it is inferred to be equal to sps_max_num_reorder_pics[sps_max_sub_layers_minus1].

sps_max_latency_increase_plus1[i] not equal to 0 is used to compute the value of SpsMaxLatencyPictures[i], which specifies the maximum number of pictures that can precede any picture in the CVS in output order and follow that picture in decoding order when HighestTid is equal to i.

When sps_max_latency_increase_plus1[i] is not equal to 0, the value of SpsMaxLatencyPictures[i] is specified as follows:

SpsMaxLatencyPictures[i]=sps_max_num_reorder_pics[i]+sps_max_latency_increase_plus1[i]−1

When sps_max_latency_increase_plus1[i] is equal to 0, no corresponding limit is expressed.

The value of sps_max_latency_increase_plus1[i] shall be in the range of 0 to 2³²−2, inclusive. When sps_max_latency_increase_plus1[i] is not present for i in the range of 0 to sps_max_sub_layers_minus1−1, inclusive, due to sps_sub_layer_ordering_info_present_flag being equal to 0, it is inferred to be equal to sps_max_latency_increase_plus1 [sps_max_sub_layers_minus1].

TABLE (6)

seq_parameter_set_rbsp( ) {

...

sps_max_sub_layers_minus1
...
pic_width_in_luma_samples
pic_height_in_luma_samples
...

for( i = ( sps_sub_layer_ordering_info_present_flag ? 0 :

sps_max_sub_layers_minus1 );

i <= sps_max_sub_layers_minus1; i++ ) {

sps_max_dec_pic_buffering_minus1[ i ]
sps_max_num_reorder_pics[ i ]
sps_max_latency_increase_plus1[ i ]

}

...
}

When the current picture is an IRAP picture and has nuh_layer_id equal to 0, the following applies:
The variable NoClrasOutputFlag is specified as follows:
If the current picture is the first picture in the bitstream, NoClrasOutputFlag is set equal to 1.
Otherwise, if the current picture is a BLA picture, NoClrasOutputFlag is set equal to 1.
Otherwise, if some external means not specified in this Specification is available to set NoClrasOutputFlag, NoClrasOutputFlag is set by the external means.
Otherwise, NoClrasOutputFlag is set equal to 0.
When NoClrasOutputFlag is equal to 1, the variable LayerInitialisedFlag[i] is set equal to 0 for all values of i from 0 to 63, inclusive, and the variable FirstPicInLayerDecodedFlag[i] is set equal to 0 for all values of i from 1 to 63, inclusive.

When the current picture is an IRAP picture, the following applies:

If the current picture with a particular value of nuh_layer_id is an IDR picture, a BLA picture, the first picture with that particular value of nuh_layer_id in the bitstream in the bitstream in decoding order, or the first picture with that particular value of nuh_layer_id that follows an end of sequence NAL unit in decoding order, a variable NoRasIOutputFlag is set equal to 1.

Otherwise, if some external means is available to set a variable HandleCraAsBlaFlag to a value for the current picture, the variable HandleCraAsBlaFlag is set equal to the value provided by that external means and the variable NoRasIOutputFlag is set equal to HandleCraAsBlaFlag.

Otherwise, the variable HandleCraAsBlaFlag is set equal to 0 and the variable NoRasIOutputFlag is set equal to 0.

When the current picture is an IRAP picture and one of the following conditions is true, LayerInitialisedFlag[nuh_layer_id] is set equal to 1:

nuh_layer_id is equal to 0.

LayerInitialisedFlag[nuh_layer_id] is equal to 0 and

LayerInitialisedFlag[refLayerId] is equal to 1 for all values of refLayerId equal to RefLayerId[nuh_layer_id][j], where j is in the range of 0 to NumDirectRefLayers[nuh_layer_id]−1, inclusive.

Within the decoding process for ending the decoding of a coded picture with nuh_layer_id greater than 0 FirstPicInLayerDecodedFlag[nuh_layer_id] is set equal to 1.

If the current picture is an IRAP picture with NoRasIOutputFlag equal to 1 that is not picture 0, the following ordered steps are applied:
1. The variable NoOutputOfPriorPicsFlag is derived for the decoder under test as follows:
   If the current picture is a CRA picture, NoOutputOfPriorPicsFlag is set equal to 1 (regardless of the value of no_output_of prior_pics_flag).
   Otherwise, if the value of pic_width_in_luma_samples, pic_height_in_luma_samples, or
sps_max_dec_pic_buffering_minus1[HighestTid] derived from the active SPS is different from the value of pic_width_in_luma_samples, pic_height_in_luma_samples, or
sps_max_dec_pic_buffering_minus1[HighestTid], respectively, derived from the SPS active for the preceding picture, NoOutputOfPriorPicsFlag may (but should not) be set to 1 by the decoder under test, regardless of the value of no_output_of prior_pics_flag.
   Otherwise, NoOutputOfPriorPicsFlag is set equal to no_output_of prior_pics_flag.
2. The value of NoOutputOfPriorPicsFlag derived for the decoder under test is applied for the HRD as follows:
   If NoOutputOfPriorPicsFlag is equal to 1, all picture storage buffers in the DPB are emptied without output of the pictures they contain, and the DPB fullness is set equal to 0.
   Otherwise (NoOutputOfPriorPicsFlag is equal to 0), all picture storage buffers containing a picture that is marked as “not needed for output” and “unused for reference” are emptied (without output), and all non-empty picture storage buffers in the DPB are emptied by repeatedly invoking the “bumping” process 1204, and the DPB fullness is set equal to 0.
   Otherwise (the current picture is not an IRAP picture with NoRasIOutputFlag equal to 1), all picture storage buffers containing a picture which are marked as “not needed for output” and “unused for reference” are emptied (without output). For each picture storage buffer that is emptied, the DPB fullness is decremented by one. When one or more of the following conditions are true, the “bumping” process 1204 is invoked repeatedly while further decrementing the DPB fullness by one for each additional picture storage buffer that is emptied, until none of the following conditions are true:
1. The number of pictures with that particular nuh_layer_id value in the DPB that are marked as “needed for output” is greater than sps_max_num_reorder_pics[HighestTid] from the active sequence parameter set (when that particular nuh_layer_id value is equal to 0) or from the active layer sequence parameter set for that particular nuh_layer_id value.
2. If sps_max_latency_increase_plus1 [HighestTid] from the active sequence parameter set (when that particular nuh_layer_id value is equal to 0) or from the active layer sequence parameter set for that particular nuh_layer_id value is not equal to 0 and there is at least one picture with that particular nuh_layer_id value in the DPB that is marked as “needed for output” for which the associated variable PicLatencyCount is greater than or equal to SpsMaxLatencyPictures[HighestTid] for that particular nuh_layer_id value.
3. The number of pictures with that particular nuh_layer_id value in the DPB is greater than or equal to sps_max_dec_pic_buffering[HighestTid]+1 from the active sequence parameter set (when that particular nuh_layer_id value is equal to 0) or from the active layer sequence parameter set for that particular nuh_layer_id value.

Picture decoding process in the block 1206 (picture decoding and marking) happens instantaneously when the last decoding unit of access unit containing the current picture is removed from the CPB.

For each picture with nuh_layer_id value equal to current picture's nuh_layer_id value in the DPB that is marked as “needed for output”, the associated variable PicLatencyCount is set equal to PicLatencyCount+1.

The current picture is considered as decoded after the last decoding unit of the picture is decoded. The current decoded picture is stored in an empty picture storage buffer in the DPB, and the following applies:
If the current decoded picture has PicOutputFlag equal to 1, it is marked as “needed for output” and its associated variable PicLatencyCount is set equal to 0.
Otherwise (the current decoded picture has PicOutputFlag equal to 0), it is marked as “not needed for output”.

The current decoded picture is marked as “used for short-term reference”.

When one or more of the following conditions are true, the additional “bumping” process 1208 is invoked repeatedly until none of the following conditions are true:

The number of pictures with nuh_layer_id value equal to current picture's nuh_layer_id value in the DPB that are marked as “needed for output” is greater than sps_max_num_reorder_pics[HighestTid] from the active sequence parameter set (when the current picture's nuh_layer_id value is equal to 0) or from the active layer sequence parameter set for the current picture's nuh_layer_id value.

sps_max_latency_increase_plus1 [HighestTid] from the active sequence parameter set (when the current picture's nuh_layer_id value is equal to 0) or from the active layer sequence parameter set for the current picture's nuh_layer_id value is not equal to 0 and there is at least one picture with that particular nuh_layer_id value in the DPB that is marked as “needed for output” for which the associated variable PicLatencyCount is greater than or equal to SpsMaxLatencyPictures[HighestTid] for that particular nuh_layer_id value.

The “bumping” process 1204 and additional bumping process 1208 are identical in terms of the steps and consists of the following ordered steps: The pictures that are first for output is selected as the ones having the smallest value of picture order count (PicOrderCntVal) of all pictures in the DPB marked as “needed for output”. A picture order count is a variable that is associated with each picture, uniquely identifies the associated picture among all pictures in the CVS, and, when the associated picture is to be output from the decoded picture buffer, indicates the position of the associated picture in output order relative to the output order positions of the other pictures in the same CVS that are to be output from the decoded picture buffer.

These pictures are cropped, using the conformance cropping window specified in the active sequence parameter set for the picture with nuh_layer_id equal to 0 or in the active layer sequence parameter set for a nuh_layer_id value equal to that of the picture, the cropped pictures are output in ascending order of nuh_layer_id, and the pictures are marked as “not needed for output”.

Each picture storage buffer that contains a picture marked as “unused for reference” and that included one of the pictures that was cropped and output is emptied.

Table (7) shows an exemplary video parameter set (VPS) sytax structure

vps_video_parameter_set_id identifies the VPS for reference by other syntax elements.

vps_max_layers_minus1 shall be equal to 0 in bitstreams conforming to this version of this Specification. Other values for vps_max_layers_minus1 are reserved for future use by ITU-T|ISO/IEC. Although the value of vps_max_layers_minus1 is required to be equal to 0 in this version of this Specification, decoders shall allow other values of vps_max_layers_minus1 to appear in the syntax.

vps_max_sub_layers_minus1 plus 1 specifies the maximum number of temporal sub-layers that may be present in the bitstream. The value of vps_max_sub_layers_minus1 shall be in the range of 0 to 6, inclusive.

vps_temporal_id_nesting_flag, when vps_max_sub_layers_minus1 is greater than 0, specifies whether inter prediction is additionally restricted for CVSs referring to the VPS. When vps_max_sub_layers_minus1 is equal to 0, vps_temporal_id_nesting_flag shall be equal to 1.

vps_sub_layer_ordering_info_present_flag equal to 1 specifies that vps_max_dec_pic_buffering_minus1[i], vps_max_num_reorder_pics[i], and vps_max_latency_increase_plus1[i] are present for vps_max_sub_layers_minus1+1 sub-layers. vps_sub_layer_ordering_info_present_flag equal to 0 specifies that the values of vps_max_dec_pic_buffering_minus1[vps_max_sub_layers_minus1], vps_max_num_reorder_pics[vps_max_sub_layers_minus1], and vps_max_latency_increase_plus1 [vps_max_sub_layers_minus1] apply to all sub-layers.

vps_max_dec_pic_buffering_minus1[i] plus 1 specifies the maximum required size of the decoded picture buffer for the CVS in units of picture storage buffers when HighestTid is equal to i. The value of vps_max_dec_pic_buffering_minus1[i] shall be in the range of 0 to MaxDpbSize−1 (as specified in subclause A.4), inclusive. When i is greater than 0, vps_max_dec_pic_buffering_minus1[i] shall be greater than or equal to vps_max_dec_pic_buffering_minus1 [i−1]. When vps_max_dec_pic_buffering_minus1[i] is not present for i in the range of 0 to vps_max_sub_layers_minus1−1, inclusive, due to vps_sub_layer_ordering_info_present_flag being equal to 0, it is inferred to be equal to vps_max_dec_pic_buffering_minus1[vps_max_sub_layers_minus1].

vps_max_num_reorder_pics[i] indicates the maximum allowed number of pictures that can precede any picture in the CVS in decoding order and follow that picture in output order when HighestTid is equal to i. The value of vps_max_num_reorder_pics[i] shall be in the range of 0 to vps_max_dec_pic_buffering_minus1[i], inclusive. When i is greater than 0, vps_max_num_reorder_pics[i] shall be greater than or equal to vps_max_num_reorder_pics[i−1]. When vps_max_num_reorder_pics[i] is not present for i in the range of 0 to vps_max_sub_layers_minus1−1, inclusive, due to vps_sublayer ordering_info_present_flag being equal to 0, it is inferred to be equal to vps_max_num_reorder_pics[vps_max_sub_layers_minus1].

vps_max_latency_increase_plus1[i] not equal to 0 is used to compute the value of VpsMaxLatencyPictures[i], which specifies the maximum number of pictures that can precede any picture in the CVS in output order and follow that picture in decoding order when HighestTid is equal to i.

When vps_max_latency_increase_plus1[i] is not equal to 0, the value of VpsMaxLatencyPictures[i] is specified as follows:

VpsMaxLatencyPictures[i]=vps_max_num_reorder_pics[i]+vps_max_latency_increase_plus1[i]−1

When vps_max_latency_increase_plus1[i] is equal to 0, no corresponding limit is expressed.
The value of vps_max_latency_increase_plus1[i] shall be in the range of 0 to 2³²−2, inclusive. When vps_max_latency_increase_plus1[i] is not present for i in the range of 0 to vps_max_sub_layers_minus1−1, inclusive, due to vps_sub_layer_ordering_info_present_flag being equal to 0, it is inferred to be equal to vps_max_latency_increase_plus1[vps_max_sub_layers_minus1].

vps_max_layer_id specifies the maximum allowed value of nuh_layer_id of all NAL units in the CVS.

vps_num_layer_sets_minus1 plus 1 specifies the number of layer sets that are specified by the VPS. In bitstreams conforming to this version of this Specification, the value of vps_num_layer_sets_minus1 shall be equal to 0. Although the value of vps_num_layer_sets_minus1 is required to be equal to 0 in this version of this Specification, decoders shall allow other values of vps_num_layer_sets_minus1 in the range of 0 to 1023, inclusive, to appear in the syntax.

layer_id_included_flag[i][j] equal to 1 specifies that the value of nuh_layer_id equal to j is included in the layer identifier list layerSetLayerIdList[i]. layer_id_included_flag[i][j] equal to 0 specifies that the value of nuh_layer_id equal to j is not included in the layer identifier list layerSetLayerIdList[i].

The value of numLayersInIdList[0] is set equal to 1 and the value of layerSetLayerIdList[0][0] is set equal to 0.
For each value of i in the range of 1 to vps_num_layer_sets_minus1, inclusive, the variable numLayersInIdList[i] and the layer identifier list layerSetLayerIdList[i] are derived as follows:

n=0

for(m=0; m<=vps_max_layer_id; m++)
if (layer_id_included_flag[i][m]) (73)
   layerSetLayerIdList[i][n++]=m
      numLayersInIdList[i]=n
      For each value of i in the range of 1 to vps_num_layer_sets_minus1, inclusive, numLayersInIdList[i] shall be in the range of 1 to vps_max_layers_minus1+1, inclusive.
      When numLayersInIdList[iA] is equal to numLayersInIdList[iB] for any iA and iB in the range of 0 to vps_num_layer_sets_minus1, inclusive, with iA not equal to iB, the value of layerSetLayerIdList[iA][n] shall not be equal to layerSetLayerIdList[iB][n] for at least one value of n in the range of 0 to numLayersInIdList[iA], inclusive.
      A layer set is identified by the associated layer identifier list. The i-th layer set specified by the VPS is associated with the layer identifier list layerSetLayerIdList[i], for i in the range of 0 to vps_num_layer_sets_minus1, inclusive.
      A layer set consists of all operation points that are associated with the same layer identifier list.

Each operation point is identified by the associated layer identifier list, denoted as OpLayerIdList, which consists of the list of nuh_layer_id values of all NAL units included in the operation point, in increasing order of nuh_layer_id values, and a variable OpTid, which is equal to the highest TemporalId of all NAL units included in the operation point. The bitstream subset associated with the operation point identified by OpLayerIdList and OpTid is the output of the sub-bitstream extraction process as specified in clause 10 with the bitstream, the target highest TemporalId equal to OpTid, and the target layer identifier list equal to OpLayerIdList as inputs. The OpLayerIdList and OpTid that identify an operation point are also referred to as the OpLayerIdList and OpTid associated with the operation point, respectively.

TABLE(7)
De-
scrip-
tor

video_parameter_set_rbsp( ) {

| | |
|---|---|
| vps_video_parameter_set_id | u(4) |
| ... | |
| vps_max_layers_minus1 | u(6) |
| vps_max_sub_layers_minus1 | u(3) |
| vps_temporal_id_nesting_flag | u(1) |
| ... | |
| vps_sub_layer_ordering_info_present_flag | u(1) |
| for( i = ( vps_sub_layer_ordering_info_present_flag ? 0 : | |

vps_max_sub_layers_minus1 );

i <= vps_max_sub_layers_minus1; i++ ){

| | |
|---|---|
| vps_max_dec_pic_buffering_minus1[ i ] | ue(v) |
| vps_max_num_reorder_pics[ i ] | ue(v) |
| vps_max_latency_increase_plus1[ i ] | ue(v) |

| | |
|---|---|
| } | |
| vps_max_layer_id | u(6) |
| vps_num_layer_sets_minus1 | ue(v) |
| for( i = 1; i <= vps_num_layer_sets_minus1; i++ ) | |

for( j = 0; j <= vps_max_layer_id; j++ )

| | |
|---|---|
| layer_id_included_flag[ i ][ j ] | u(1) |

...

}

Table (8) shows an exemplary video parameter set (VPS) extension sytax structure

vps_nuh_layer_id_present_flag equal to 1 specifies that layer_id_in_nuh[i] for i from 0 to vps_max_layers_minus1, inclusive, are present. vps_nuh_layer_id_present_flag equal to 0 specifies that layer_id_in_nuh[i] for i from 0 to vps_max_layers_minus1, inclusive, are not present.

layer_id_in_nuh[i] specifies the value of the nuh_layer_id syntax element in VCL NAL units of the i-th layer. For i in the range of 0 to vps_max_layers_minus1, inclusive, when layer_id_in_nuh[i] is not present, the value is inferred to be equal to i.

When i is greater than 0, layer_id_in_nuh[i] shall be greater than layer_id_in_nuh[i−1].
For i from 0 to vps_max_layers_minus1, inclusive, the variable LayerIdxInVps[layer_id_in_nuh[i]] is set equal to i.

direct_dependency_flag[i][j] equal to 0 specifies that the layer with index j is not a direct reference layer for the layer with index i. direct_dependency_flag[i ][j] equal to 1 specifies that the layer with index j may be a direct reference layer for the layer with index i. When direct_dependency_flag[i][j] is not present for i and j in the range of 0 to vps_max_layers_minus1, it is inferred to be equal to 0.

The variables NumDirectRefLayers[i], and RefLayerId[i][j] SamplePredEnabledFlag[i][j], MotionPredEnabledFlag[i][j] and DirectRefLayerIdx[i][j] are derived as follows:

```
for( i = 0; i <= vps_max_layers_minus1; i++ ) {
    iNuhLId = layer_id_in_nuh[ i ]
    NumDirectRefLayers[ iNuhLId ] = 0
    for( j = 0; j < i; j++ )
        if( direct_dependency_flag[ i ][ j ] ) {
            RefLayerId[ iNuhLId ][ NumDirectRefLayers[
iNuhLId ]++ ] = layer_id_in_nuh[ j ]
            SamplePredEnabledFlag[ iNuhLId ][ j ] = ( (
direct_dependency_type[ i ][ j ] + 1 ) & 1 )
            MotionPredEnabledFlag[ iNuhLId ][ j ] = ( ( (
direct_dependency_type[ i ][ j ] + 1 ) & 2 ) >> 1 )
            DirectRefLayerIdx[ iNuhLid ][ layer_id_in_nuh[ j ] ] =
NumDirectRefLayers[ iNuhLId ] − 1 }
}
```

max_tid_ref_present_flag equal to 1 specifies that the syntax element max_tid_il_ref_pics_plus1[i] is present. max_tid_ref_present_flag equal to 0 specifies that the syntax element max_tid_il_ref_pics_plus1[i] is not present.

max_tid_il_ref_pics_plus1[i] equal to 0 specifies that within the CVS non-IRAP pictures with nuh_layer_id equal to layer_id_in_nuh[i] are not used as reference for inter-layer prediction. max_tid_il_ref_pics_plus1[i] greater than 0 specifies that within the CVS pictures with nuh_layer_id equal to layer_id_in_nuh[i] and TemporalId greater than max_tid_il_ref_pics_plus1[i]−1 are not used as reference for inter-layer prediction. When not present, max_tid_il_ref_pics_plus1[i] is inferred to be equal to 7.

all_ref_layers_active_flag equal to 1 specifies that for each picture referring to the VPS, the reference layer pictures of all direct reference layers of the layer containing the picture are present in the same access unit as the picture and are included in the inter-layer reference picture set of the picture. all_ref_layers_active_flag equal to 0 specifies that the above restriction may or may not apply.

max_one_active_ref_layer_flag equal to 1 specifies that at most one picture is used for inter-layer prediction for each picture in the CVS. max_one_active_ref_layer_flag equal to 0 specifies that more than one picture may be used for inter-layer prediction for each picture in the CVS.

cross_layer_irap_aligned_flag equal to 1 specifies that IRAP pictures in the CVS are cross-layer aligned, i.e. when a picture pictureA of a layer layerA in an access unit is an IRAP picture, each picture pictureB in the same access unit that belongs to a direct reference layer of layerA or that belongs to a layer for which layerA is a direct reference layer of that layer is an IRAP picture and the VCL NAL units of pictureB have the same value of nal_unit_type as that of pictureA. cross_layer_irap_aligned_flag equal to 0 specifies that the above restriction may or may not apply.

TABLE (8)

De-
scrip-
tor

vps_extension( ) {
...

| | |
|---|---|
| vps_nuh_layer_id_present_flag | u(1) |
| for( i = 1; i <= vps_max_layers_minus1; i++ ) { | |

if( vps_nuh_layer_id_present_flag )

| | |
|---|---|
| layer_id_n_nuh[ i ] | u(6) |

...

}

...

for( i = 1; i <= vps_max_layers_minus1; i++ )

for( j = 0; j < i; j++ )

| | |
|---|---|
| direct_dependency_flag[ i ][ j ] | u(1) |

| | |
|---|---|
| max_tid_ref_present_flag | u(1) |
| if( max_tid_ref_present_flag ) | |

for( i = 0; i < vps_max_layers_minus1; i++ )

| | |
|---|---|
| max_tid_il_ref_pics_plus1[ i ] | u(3) |

| | |
|---|---|
| all_ref_layers_active_flag | u(1) |
| ... | |
| max_one_active_ref_layer_flag | u(1) |
| cross_layer_irap_aligned_flag | u(1) |
| ... | |

}

Table (9) shows an exemplary picture parameter set (PPS) syntax structure

pps_pic_parameter_set_id identifies the PPS for reference by other syntax elements. The value of pps_pic_parameter_set_id shall be in the range of 0 to 63, inclusive.

num_extra_slice_header_bits equal to 0 specifies that no extra slice header bits are present in the slice header RBSP for coded pictures referring to the PPS.

TABLE (9)

De-
scrip-
tor

pic_parameter_set_rbsp( ) {

| | |
|---|---|
| pps_pic_parameter_set_id | ue(v) |
| ... | |
| num_extra_slice_header_bits | u(3) |
| ... | |

}

Table (10) shows an exemplary slice segment header syntax structure.

first_slice_segment_in_pic_flag equal to 1 specifies that the slice segment is the first slice segment of the picture in decoding order. first_slice_segment_in_pic_flag equal to 0 specifies that the slice segment is not the first slice segment of the picture in decoding order.

no_output_of_prior_pics_flag affects the output of previously-decoded pictures in the decoded picture buffer after the decoding of an IDR or a BLA picture that is not the first picture in the bitstream.

slice_pic_parameter_set_id specifies the value of pps_pic_parameter_set for the PPS in use. The value of slice_pic_parameter_set_id shall be in the range of 0 to 63, inclusive.

dependent_slice_segment_flag equal to 1 specifies that the value of each slice segment header syntax element that is not present is inferred to be equal to the value of the corresponding slice segment header syntax element in the slice header. When not present, the value of dependent_slice_segment_flag is inferred to be equal to 0.

slice_segment_address specifies the address of the first coding tree block in the slice segment, in coding tree block raster scan of a picture.

poc_reset_flag equal to 1 specifies that the derived picture order count for the current picture is equal to 0. poc_reset_flag equal to 0 specifies that the derived picture order count for the current picture may or may not be equal to 0. It is a requirement of bitstream conformance that when crosslayer_irap_aligned_flag is equal to 1, the value of poc_reset_flag shall be equal to 0. When not present, the value of poc_reset_flag is inferred to be equal to 0.

discardable_flag equal to 1 specifies that the coded picture is not used as a reference picture for inter prediction and is not used as an inter-layer reference picture in the decoding process of subsequent pictures in decoding order. discardable_flag equal to 0 specifies that the coded picture may be used as a reference picture for inter prediction and may be used as an inter-layer reference picture in the decoding process of subsequent pictures in decoding order. When not present, the value of discardable_flag is inferred to be equal to 0.

slice_reserved_flag[i] has semantics and values that are reserved for future use by ITU-T|ISO/IEC. Decoders shall ignore the presence and value of slice_reserved_flag[i].

inter_layer_pred_enabled_flag equal to 1 specifies that inter-layer prediction may be used in decoding of the current picture. inter_layer_pred_enabled_flag equal to 0 specifies that inter-layer prediction is not used in decoding of the current picture.

num_inter_layer_ref_pics_minus1 plus 1 specifies the number of pictures that may be used in decoding of the current picture for inter-layer prediction. The length of the num_inter_layer_ref_pics_minus1 syntax element is Ceil(Log 2(NumDirectRefLayers[nuh_layer_id])) bits. The value of num_inter_layer_ref_pics_minus1 shall be in the range of 0 to NumDirectRefLayers[nuh_layer_id]−1, inclusive.

The variable NumActiveRefLayerPics is derived as follows:
if(nuh_layer_id==0∥NumDirectRefLayers[nuh_layer_id]==0)

NumActiveRefLayerPics=0

else if(all_ref_layers_active_flag)

NumActiveRefLayerPics=NumDirectRefLayers[nuh_layer_id]

else if(!inter_layer_pred_enabled_flag)

NumActiveRefLayerPics=0

else if(max_one_active_ref_layer_flag∥NumDirectRefLayers[nuh_layer_id]==1)

NumActiveRefLayerPics=1

else

NumActiveRefLayerPics=num_inter_layer_ref_pics_minus1+1

All slices of a coded picture shall have the same value of NumActiveRefLayerPics.

inter_layer_pred_layer_idc[i] specifies the variable, RefPicLayerId[i], representing the nuh_layer_id of the i-th picture that may be used by the current picture for inter-layer prediction. The length of the syntax element inter_layer_pred_layer_idc[i] is Ceil(Log 2(NumDirectRefLayers[nuh_layer_id])) bits. The value of inter_layer_pred_layer_idc[i] shall be in the range of 0 to NumDirectRefLayers[nuh_layer_id]−1, inclusive. When not present, the value of inter_layer_pred_layer_idc[i] is inferred to be equal to i.

When i is greater than 0, inter_layer_pred_layer_idc[i] shall be greater than inter_layer_pred_layer_idc[i−1].
The variables RefPicLayerId[i] for all values of i in the range of 0 to NumActiveRefLayerPics−1, inclusive, are derived as follows:
for(i=0, j=0; i<NumActiveRefLayerPics; i++)

RefPicLayerId[i]=RefLayerId[nuh_layer_id][inter_layer_pred_layer_idc[i]] All slices of a picture shall have the same value of inter_layer_pred_layer_idc[i] for each value of i in the range of 0 to NumActiveRefLayerPics−1, inclusive.

It is a requirement of bitstream conformance that for each value of i in the range of 0 to NumActiveRefLayerPics−1, inclusive, either of the following two conditions shall be true:

The value of max_tid_il_ref_pics_plus1[LayerIdxInVps[RefPicLayerId[i]]] is greater than TemporalId.

The values of max_tid_il_ref_pics_plus1[LayerIdxInVps[RefPicLayerId[i]]] and TemporalId are both equal to 0 and the picture in the current access unit with nuh_layer_id equal to RefPicLayerId[i] is an IRAP picture.

TABLE (10)

De-
scrip-
tor

slice_segment_header( ) {

| | |
|---|---|
| first_slice_segment_in_pic_flag | u(1) |
| if( nal_unit_type >= BLA_W_LP && nal_unit_type <= | |

RSV_IRAP_VCL23 )

| | |
|---|---|
| no_output_of_prior_pics_flag | u(1) |

| | |
|---|---|
| ... | ue(v) |
| if( !first_slice_segment_in_pic_flag ) { | |

if( dependent_slice_segments_enabled_flag )

| | |
|---|---|
| dependent_slice_segment_flag | u(1) |

| | |
|---|---|
| slice_segment_address | u(v) |

}
if( !dependent_slice_segment_flag ) {

i = 0
if( num_extra_slice_header_bits > i ) {

| | |
|---|---|
| i++ | |
| poc_reset_flag | u(1) |

}
if( num_extra_slice_header_bits > i ) {

| | |
|---|---|
| i++ | |
| discardable_flag | u(1) |

}
for( i = 1 ; i < num_extra_slice_header_bits; i++ )

| | |
|---|---|
| slice_reserved_flag[ i ] | u(1) |

...
if( nuh_layer_id > 0 && ! all_ref_layers_active_flag

&& NumDirectRefLayers[ nuh_layer_id ] > 0 ) {

| | |
|---|---|
| inter_layer_pred_enabled_flag | u(1) |
| if( inter_layer_pred_enabled_flag && | |

NumDirectRefLayers[ nuh_layer_id ] > 1) {

if( !max_one_active_ref_layer_flag )

| | |
|---|---|
| num_inter_layer_ref_pics_minus1 | u(v) |

if( NumActiveRefLayerPics !=

NumDirectRefLayers[ nuh_layer_id ] )

for( i = 0; i < NumActiveRefLayerPics;

i++ )

| | |
|---|---|
| inter_layer_pred_layer_idc[ i ] | u(v) |

}

}
...

}
...

}

One existing technique for managing pictures within the DPB is to evaluate after decoding of slice header, whether pictures in the previous access unit for the current layer need to be maintained within the DPB. If a picture in the previous access unit of the current layer does not have to be maintained in the DPB then the picture storage corresponding to that picture is emptied. Whether a picture is to be maintained within the DPB depends on the how the picture is marked.

Another existing technique for managing storage within the DPB is to select within the “Bumping” process pictures that are first for output. These pictures are cropped, using the conformance cropping window specified in the active SPS for the picture with nuh_layer_id equal to 0 or in the active layer SPS for a non-zero nuh_layer_id value equal to that of the picture, the cropped pictures are output in ascending order of nuh_layer_id, and the pictures are marked as “not needed for output”. Each picture storage buffer that contains a picture marked as “unused for reference” and that was one of the pictures cropped and output is emptied.

While such a DPB management process is suitable for many applications there is a desirable picture management approach which is not included. A modified DPB picture management approach would include within it the ability to mark pictures in the current access unit which do not belong to the current layer. In another modified DPB picture management approach there would be the ability to not only mark pictures within the current access unit that do not belong to the current layer but also empty picture storages in the DPB corresponding to pictures within the current access unit that do not belong to the current layer. The advantage of such approaches is to facilitate faster emptying of picture storage buffers and hence reduce the maximum memory requirements for DPB.

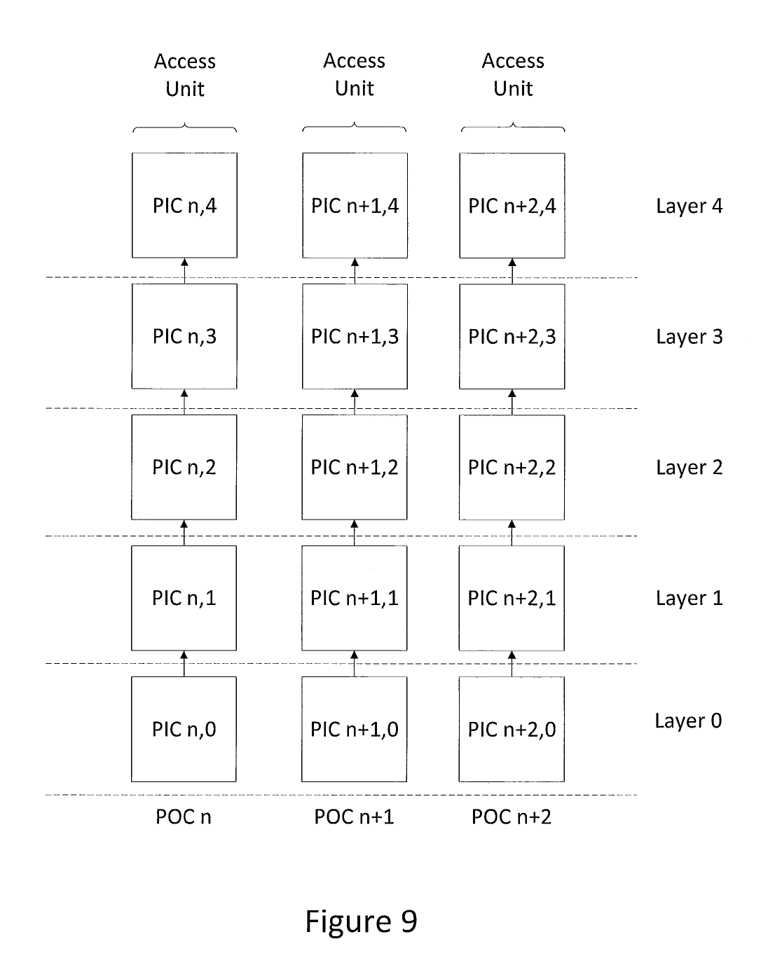

FIG. 9 illustrates an example where a picture within an access unit is not used for reference by a picture in another access unit. Also, each picture only uses the picture in the layer below within the current access unit as reference. In such a configuration, when decoding a picture in layer x, pictures at or below layer (x−2) within the current access unit can be marked as “unused for reference”. In the existing DPB management process in JCTVC-N1008 and JCT3V-E1004 marking a picture in the current access unit in a layer different than the current layer is not allowed.

A modified DPB management process which marks pictures within the current access unit may include a modified signaling of the slice header and an invokation of an inter-layer picture marking process within the decoding process for starting the decoding of a coded picture with nuh_layer_id greater than 0. The inter-layer picture marking process may use information determined based on layer dependency information signaled in the VPS extension and information signaled in the slice header. Exemplary modifications are listed below:

A First, Slice Header Modificiation—Table (11):

TABLE(11)
De-
scrip-
tor

slice_segment_header( ) {

...
if( !dependent_slice_segment_flag ) {

...
if( nuh_layer_id > 0 )

| | |
|---|---|
| unused_for_pred_in_cur_layer_flag | u(1) |

...

}
...

}

A Second, Semantic for Syntax Element Added to Slice Header:

unused_for_pred_in_cur_layer_flag equal to 1 specifies that the current picture with nuh_layer_id equal to currLayerId is not used as a reference picture for inter prediction in the decoding process of subsequent pictures in decoding order with nuh_layer_id equal to currLayerId. unused_for_pred_in_cur_layer_flag equal to 0 specifies that the current picture with nuh_layer_id equal to currLayerId may be used as a reference picture for inter prediction in the decoding process of subsequent pictures in decoding order with nuh_layer_id equal to currLayerId. When not present, the value of unused_for_pred_in_cur_layer_flag is inferred to be equal to 0.
The variable UnusedForInterPredFlag is derived as follows:
UnusedForInterPredFlag [nuh_layer_id]=unused_for_pred_in_cur_layer_flag.
It is a requirement of bitstream conformance that the value of unused_for_pred_in_cur_layer_flag shall be the same for all slices of a coded picture.

A Third, Information Determined from Layer Dependency Sytnax Elements Signaled in VPS Extension:

The variable UsedForInterLyrRefFlag[i][j] is derived as follows:

```
for( i = 0; i <= vps_max_layers_minus1; i++ ) {
    iNuhLId = layer_id_in_nuh[ i ]
    ...
    for( j = 0; j < i; j++ ) {
        ...
        for( k = i, UsedForInterLyrRefFlag[ iNuhLId ][ j ] = 0; k <=
vps_max_layers_minus1 &&
!UsedForInterLyrRefFlag[ iNuhLId ][ j ]; k++ )
            if (direct_dependency_flag[ k ][ j ])
                UsedForInterLyrRefFlag[ iNuhLId ][ j ] = 1
    }
}
```

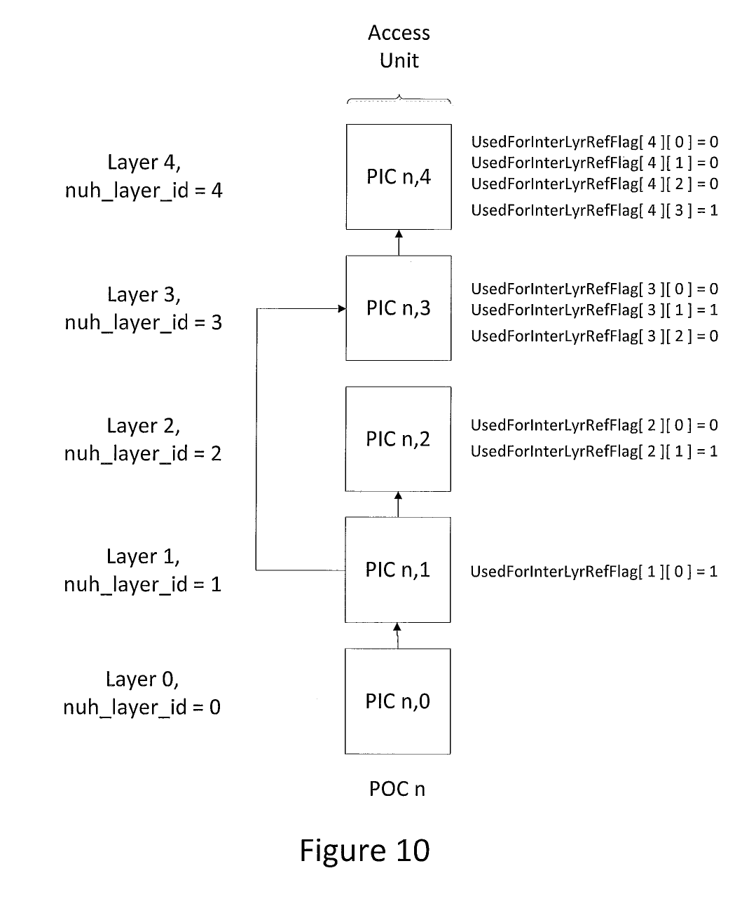

The value of array element UsedForInterLyrRefFlag[i][j] is set equal to 1 for the current picture with nuh_layer_id i, when the inter-layer picture with layer index j (and having nuh_layer_id equal to layer_id_in_nuh[j]) is used as direct reference by at least one layer with index greater than or equal to LayerIdxInVPS[i]. The value of array element UsedForInterLyrRefFlag[i][j] is set equal to 0 for layer with nuh_layer_id when the inter-layer picture with layer index j (and having nuh_layer_id equal to layer_id_in_nuh[j]) is not used as direct reference by any layer with index greater than or equal to LayerIdxInVPS[i]. FIG. 10 illustrates values for array UsedForInterLyrRefFlag for an exemplary layer dependency structure. The prediction structure depicted in FIG. 10 corresponds to the layer dependency information signalled in the VPS extension.

A Fourth, Decoding Process Change

Decoding process for starting the decoding of a coded picture with nuh_layer_id greater than 0

Each picture referred to in this subclause is a complete coded picture.
The decoding process operates as follows for the current picture CurrPic:
1. The decoding of NAL units is specified in subclause 4.
2. The following decoding processes using syntax elements in the slice segment layer and above:
   Variables and functions relating to picture order count are derived. This needs to be invoked only for the first slice segment of a picture. It is a requirement of bitstream conformance that PicOrderCntVal shall remain unchanged within an access unit.
   The decoding process for RPS is invoked, wherein only reference pictures with a nuh_layer_id equal to that of CurrPic may be marked as “unused for reference” or “used for long-term reference” and any picture with a different value of nuh_layer_id is not marked. This needs to be invoked only for the first slice segment of a picture.
   When FirstPicInLayerDecodedFlag[nuh_layer_id] is equal to 0, the decoding process for generating unavailable reference pictures is invoked, which needs to be invoked only for the first slice segment of a picture.
   For i in the range of 0 to LayerIdxInVps[nuh_layer_id]−1, inclusive, the following applies:
      Let bPic be the picture in the current access unit with nuh_layer_id equal to layer_id_in_nuh[i].
      When LayerinitialisedFlag[layer_id_in_nuh[i]] is equal to 1, FirstPicInLayerDecodedFlag[layer_id_in_nuh[i]] is equal to 1, UsedForInterLyrRefFlag[nuh_layer_id][i] is equal to 0, UnusedForInterPredFlag[layer_id_in_nuh[i]] is equal to 1, and bPic is present in the decoded picture buffer, the decoded picture bPic is marked as “unused for reference”

The decoding process for starting the decoding of a coded picture with nuh_layer_id greater than 0 is invoked for decoding of the slice segment header of the first slice, in decoding order, of the current picture. A part of the decoding process for starting the decoding of a coded picture with nuh_layer_id greater than 0 is aimed at determining pictures which are no longer needed for reference by examining if a decoded picture in the current access unit is no longer needed as a reference picture. The decoder determines this by ensuring that the corresponding value of array UsedForInterLyrRefFlag indicates that the picture under consideration is not used as reference in its own layer by other pictures which follow it in decoding order. The decoder also also ensures that the picture under consideration is not used for reference in the current access unit by pictures at or above the current layer. In addition the decoder may ensure that the layer corresponding to the picture under consideration has been initialized and the first picture in the layer has been decoded. When all the conditions are met the picture under consideration is marked as “unused for reference”. In some decoder embodiments the decoder may not ensure that the layer corresponding to the picture under consideration has been initialized and the first picture in the layer has been decoded when determining if the conditions necessary to mark the picture under .consideration as “unused for reference” is met.

Another modified DPB management process which marks pictures within the current access unit may include a modified signaling of the slice header and an invokation of an inter-layer picture marking process within the decoding process for ending the decoding of a coded picture with nuh_layer_id greater than 0. The inter-layer picture marking process may use information determined based on layer dependency information signaled in the VPS extension and information signaled in the slice header. Exemplary modifications are listed below:

A First, Slice Header Modificiation—Table (12):

TABLE(12)
De-
scrip-
tor

slice_segment_header( ) {

...
if( !dependent_slice_segment_flag ) {

...
if( nuh_layer_id > 0 )

| | |
|---|---|
| unused_for_pred_in_cur_layer_flag | u(1) |

...

}
...

}

A Second, Semantic for Syntax Element Added to Slice Header:

unused_for_pred_in_cur_layer_flag equal to 1 specifies that the current picture with nuh_layer_id equal to currLayerId is not used as a reference picture for inter prediction in the decoding process of subsequent pictures in decoding order with nuh_layer_id equal to currLayerId. unused_for_pred_in_cur_layer_flag equal to 0 specifies that the current picture with nuh_layer_id equal to currLayerId may be used as a reference picture for inter prediction in the decoding process of subsequent pictures in decoding order with nuh_layer_id equal to currLayerId. When not present, the value of unused_for_pred_in_cur_layer_flag is inferred to be equal to 0.
The variable UnusedForInterPredFlag is derived as follows:
UnusedForInterPredFlag[nuh_layer_id]=unused_for_pred_in_cur_layer_flag.
It is a requirement of bitstream conformance that the value of unused_for_pred_in_cur_layer_flag shall be the same for all slices of a coded picture.

A Third, Information Determined from Layer Dependency Sytnax Elements Signaled in VPS Extension:

The variable UsedForInterLyrRefFlagE2[i][j] is derived as follows:

```
for( i = 0; i <= vps_max_layers_minus1; i++ ) {
    iNuhLId = layer_id_in_nuh[ i ]
    ...
    for( j = 0; j < i; j++ ) {
        ...
        for( k = i+1, UsedForInterLyrRefFlagE2[ iNuhLId ][ j ] = 0;
k <= vps_max_layers_minus1 &&
!UsedForInterLyrRefFlagE2[ iNuhLId ][ j ]; k++ )
            if (direct_dependency_flag[ k ][ j ])
                UsedForInterLyrRefFlagE2[ iNuhLId ][ j ] = 1
    }
}
```

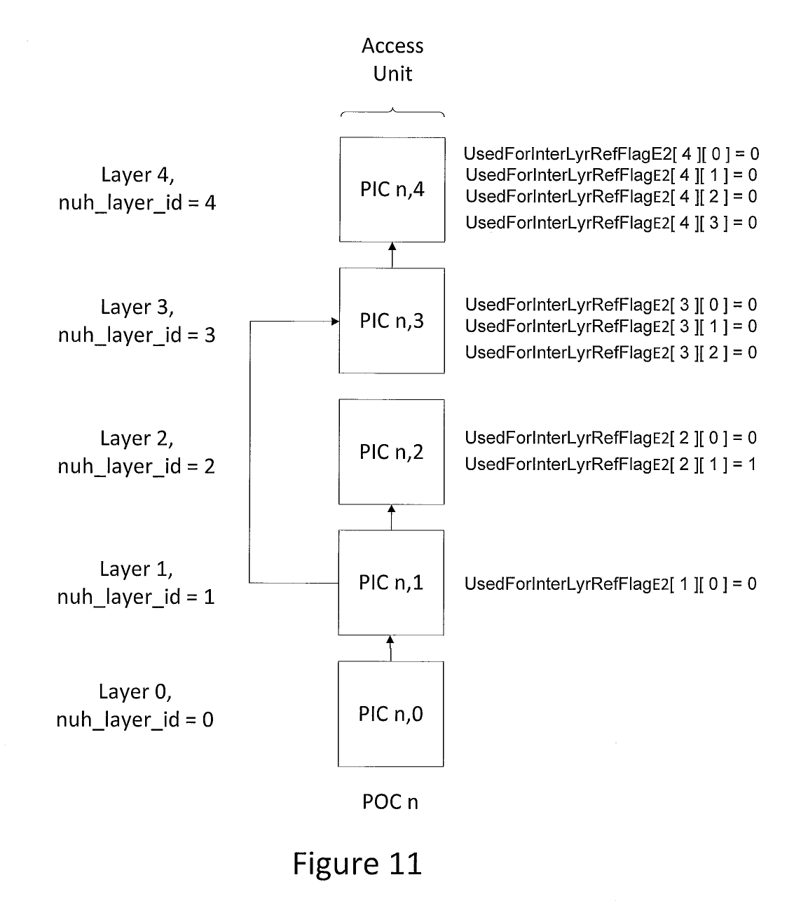

The value of array element UsedForInterLyrRefFlagE2[i][j] is set equal to 1 for the layer with nuh_layer_id i, when the inter-layer picture with layer index j (and having nuh_layer_id equal to layer_id_in_nuh[j]) is used as direct reference by at least one layer with index greater than LayerIdxInVPS[i]. The value of array element UsedForInterLyrRefFlagE2[i][j] is set equal to 0 for the layer with nuh_layer_id i, when the inter-layer picture with layer index j (and having nuh_layer_id equal to layer_id_in_nuh[j]) is not used as direct reference by any layer with index greater than LayerIdxInVPS[i]. FIG. 11 illustrates values for array UsedForInterLyrRefFlagE2 for an exemplary layer dependency structure. The prediction structure depicted in FIG. 11 corresponds to the layer dependency information signalled in the VPS extension.

A Fourth, Decoding Process Change

Decoding process for ending the decoding of a coded picture with nuh_layer_id greater than 0
PicOutputFlag is set as follows:

If the current picture is a RASL picture and NoRasIOutputFlag of the associated IRAP picture is equal to 1, PicOutputFlag is set equal to 0.

Otherwise, if LayerInitialisedFlag[nuh_layer_id] is equal to 0, PicOutputFlag is set equal to 0.

Otherwise, PicOutputFlag is set equal to pic_output_flag.

The following applies:

If discardable_flag is equal to 1, the decoded picture is marked as “unused for reference”.

Otherwise, the decoded picture is marked as “used for short-term reference”.

When TemporalId is equal to HighestTid, the marking process for sub-layer non-reference pictures not needed for inter-layer prediction is invoked with latestDecLayerId equal to nuh_layer_id as input.
FirstPicInLayerDecodedFlag[nuh_layer_id] is set equal to 1.
For i in the range of 0 to LayerIdxInVps[nuh_layer_id]−1, inclusive, the following applies:
Let bPic be the picture in the current access unit with nuh_layer_id equal to layer_id_in_nuh[i].
When LayerinitialisedFlag[layer_id_in_nuh[i]] is equal to 1, FirstPicInLayerDecodedFlag[layer_id_in_nuh[i]] is equal to 1, UsedForInterLyrRefFlagE2[nuh_layer_id][i is equal to 0, UnusedForInterPredFlag[layer_id_in_nuh[i]] is equal to 1, and bPic is present in the decoded picture buffer, the decoded picture bPic is marked as “unused for reference”

The decoding process for ending the decoding of a coded picture with nuh_layer_id greater than 0 is invoked after all slices of the current picture have been decoded. A part of the decoding process for ending the decoding of a coded picture with nuh_layer_id greater than 0 is aimed at determining pictures which are no longer needed for reference by examining if a decoded picture in the current access unit is no longer needed as a reference picture. The decoder determines this by ensuring that the corresponding value of array UsedForInterLyrRefFlagE2 indicates that the picture under consideration is not used as reference in its own layer by other pictures which follow it in decoding order. The decoder also also ensures that the picture under consideration is not used for reference in the current access unit by pictures above the current layer. In addition the decoder may ensure that the layer corresponding to the picture under consideration has been initialized and the first picture in the layer has been decoded. When all the conditions are met the picture under consideration is marked as “unused for reference”. In some decoder embodiments the decoder may not ensure that the layer corresponding to the picture under consideration has been initialized and the first picture in the layer has been decoded when determining if the conditions necessary to mark the picture under .consideration as “unused for reference” is met.

In an example embodiment the unused_for_pred_in_cur_layer_flag syntax element is signalled for layer with nuh_layer_id 0 as well. In such an event one of the slice reserved bits may be use for signaling unused_for_pred_in_cur_layer_flag. An exemplary slice segment header syntax structure is shown in Table (13)

TABLE(13)
De-
scrip-
tor

slice_segment_header( ) {

| | |
|---|---|
| ... | ue(v) |
| if( !dependent_slice_segment_flag ) { | |

i = 0
if( num_extra_slice_header_bits > i ) {

| | |
|---|---|
| i++ | |
| poc_reset_flag | u(1) |

}
if( num_extra_slice_header_bits > i ) {

| | |
|---|---|
| i++ | |
| discardable_flag | u(1) |

}
if( num_extra_slice_header_bits > i ) {

| | |
|---|---|
| i++ | |
| unused_for_pred_in_cur_layer_flag | u(1) |

}
for( i = 1; i < num_extra_slice_header_bits; i++ )

| | |
|---|---|
| slice_reserved_flag[ i ] | u(1) |

...

}
...

}

Where, unused_for_pred_in_cur_layer_flag equal to 1 specifies that the current picture with nuh_layer_id equal to currLayerId is not used as a reference picture for inter prediction in the decoding process of subsequent pictures in decoding order with nuh_layer_id equal to currLayerId. unused_for_pred_in_cur_layer_flag equal to 0 specifies that the current picture with nuh_layer_id equal to currLayerId may be used as a reference picture for inter prediction in the decoding process of subsequent pictures in decoding order with nuh_layer_id equal to currLayerId. When not present, the value of unused_for_pred_in_cur_layer_flag is inferred to be equal to 0.
The variable UnusedForInterPredFlag is derived as follows:
UnusedForInterPredFlag[nuh_layer_id]=unused_for_pred_in_cur_layer_flag.
It is a requirement of bitstream conformance that the value of unused_for_pred_in_cur_layer_flag shall be the same for all slices of a coded picture.

Another modified DPB management process which marks pictures within the current access unit may include a modified signaling of the slice header and an invokation of an inter-layer picture marking process within the decoding process for starting the decoding of a coded picture with nuh_layer_id greater than 0. The inter-layer picture marking process may use information determined based on layer dependency information signaled in the VPS extension and information signaled in the slice header. Exemplary modifications are listed below:

A First, Slice Header Modificiation—Table (14):

TABLE(14)
De-
scrip-
tor

slice_segment_header( ) {

| | |
|---|---|
| ... | ue(v) |
| if( !dependent_slice_segment_flag ) { | |

i = 0
if( num_extra_slice_header_bits > i ) {

| | |
|---|---|
| i++ | |
| poc_reset_flag | u(1) |

}
if( num_extra_slice_header_bits > i ) {

| | |
|---|---|
| i++ | |
| discardable_flag | u(1) |

}
if( num_extra_slice_header_bits > i ) {

| | |
|---|---|
| i++ | |
| unused_for_pred_in_cur_layer_flag | u(1) |

}
for( i = 1 ; i < num_extra_slice_header_bits; i++ )

| | |
|---|---|
| slice_reserved_flag[ i ] | u(1) |

...
if( nuh_layer_id > 0 )

for( i=0; i<NumLayersReferencedAbove[
nuh_layer_id ]; i++)

if(UnusedForInterPredFlag[ LayerIdRefAbove[

nuh_layer_id ][ i ] ])

| | |
|---|---|
| used_for_pred_in_layers_above[ i ] | u(1) |

...

}
...

}

A Second, Semantic for Syntax Element Added to Slice Header:

used_for_pred_in_layers_above[i] equal to 1 specifies that the picture in the current access unit with nuh_layer_id equal to LayerIdRefAbove[nuh_layer_id][i] is used for inter-layer prediction (both pixel and motion) by a higher layer picture. used_for_pred_in_layers_above[i] equal to 0 specifies that the picture in the current access unit with nuh_layer_id equal to LayerIdRefAbove[nuh_layer_id][i] is not used for inter-layer prediction by a higher layer picture. When not present, the value of used_for_pred_in_layers_above[i] is inferred to be equal to 0.
The variable UsedForPredInLayersAbove[i][j] is derived as follows:
for (j=0; j<NumLayersReferencedAbove[nuh_layer_id]; j++)

UsedForPredInLayersAbove[nuh_layer_id][j]=used_for_pred_in_layers_above[j]

Note, the syntax element used_for_pred_in_layers_above[i] is only signalled if the picture corresponding to index i is not used for reference in its own layer by subsequent decoded pictures and also it is not used as reference by current picture being decoded. This additional signalling of used_for_pred_in_layers_above[i] helps accommodate any changes to the layer dependency information signaled in VPS achieved with additional syntax elements signaled in the slice header. Specifically, any layer(s) which are not needed for inter-layer prediction earlier than that determined by layer dependency information in the VPS can be identified using used_for_pred_in_layers_above[i]. unused_for_pred_in_cur_layer_flag equal to 1 specifies that the current picture with nuh_layer_id equal to currLayerId is not used as a reference picture for inter prediction in the decoding process of subsequent pictures in decoding order with nuh_layer_id equal to currLayerId. unused_for_pred_in_cur_layer_flag equal to 0 specifies that the current picture with nuh_layer_id equal to currLayerId may be used as a reference picture for inter prediction in the decoding process of subsequent pictures in decoding order with nuh_layer_id equal to currLayerId. When not present, the value of unused_for_pred_in_cur_layer_flag is inferred to be equal to 0.
The variable UnusedForInterPredFlag is derived as follows:
UnusedForInterPredFlag[nuh_layer_id]=unused_for_pred_in_cur_layer_flag.
It is a requirement of bitstream conformance that the value of unused_for_pred_in_cur_layer_flag shall be the same for all slices of a coded picture.
Note in a variant embodiment, the syntax element unused_for_pred_in_cur_layer_flag may be signaled only within slice headers with nuh_layer_id greater than 0.

A Third, Information Determined from Layer Dependency Sytnax Elements Signaled in VPS Extension:

The variables NumLayersReferencedAbove[i] and LayerIdRefAbove[i][j] are derived as follows:

```
for( i = 0; i <= vps_max_layers_minus1; i++ ) {
    iNuhLId = layer_id_in_nuh[ i ]
    ...
    for( j = 0; j < i; j++ ) {
        ...
        NumLayersReferencedAbove[ iNuhLId ] = 0
        ReferencedFlag = 0
        for( k = i+1; k <= vps_max_layers_minus1 ; k++ )
            if (direct_dependency_flag[ k ][ j ] &&
            ReferencedFlag = = 0) {
                ReferencedFlag = 1
                LayerIdRefAbove[ iNuhLId ][
NumLayersReferencedAbove[ iNuhLId ]++ ] = layer_id_in_nuh[ j ]
            }
    }
}
```

The value of array element NumLayersReferencedAbove[i] is set equal to the number of layers with layer index less than LayerIdxInVPS[i] which may be used as a direct reference layer by layers with index greater than LayerIdxInVPS[i], where i is the nuh_layer_id of the current picture being decoded. The value of array element LayerIdRefAbove[x][y] is set equal to the nuh_layer_id of the y-th layer referenced by layers above the layer with nuh_layer_id x. These two array elements help identify layers below the current layer which may be used as direct reference by current and above layers. A flag is then signalled in the slice header indicating if the identified layer is used for reference in the current access unit.

A Fourth, Decoding Process Change

Decoding process for starting the decoding of a coded picture with nuh_layer_id greater than 0
Each picture referred to in this subclause is a complete coded picture.
The decoding process operates as follows for the current picture CurrPic:
1. The decoding of NAL units is specified in subclause 4.
2. The following decoding processes using syntax elements in the slice segment layer and above:
   Variables and functions relating to picture order count are derived. This needs to be invoked only for the first slice segment of a picture. It is a requirement of bitstream conformance that PicOrderCntVal shall remain unchanged within an access unit.
   The decoding process for RPS is invoked, wherein only reference pictures with a nuh_layer_id equal to that of CurrPic may be marked as “unused for reference” or “used for long-term reference” and any picture with a different value of nuh_layer_id is not marked. This needs to be invoked only for the first slice segment of a picture.
   When FirstPicInLayerDecodedFlag[nuh_layer_id] is equal to 0, the decoding process for generating unavailable reference pictures is invoked, which needs to be invoked only for the first slice segment of a picture.
   The marking process for inter-layer reference pictures not needed for prediction (listed below) is invoked with nuh_layer_id of CurrPic as input.
      Marking process for inter-layer reference pictures not needed for prediction Input to this process is:

a nuh_layer_id value currLayerId

Output of this process is:

potentially updated marking as “unused for reference” for some decoded pictures For layerId in the range of 0 to currLayerId−1, inclusive, the following applies:
Let IPic be the picture in the current access unit with nuh_layer_id equal to layerId
When IPic is present in the decoded picture buffer, UnusedForInterPredFlag[layerId] is equal to 1, the following applies:
   The variable usedForRefFlag is derived as specified in the following:
      usedForRefFlag=0
      for (i=0; i<NumLayersReferencedAbove[currLayerId]; i++)

if(LayerIdRefAbove[currLayerId][i]==layerId && UsedForPredInLayersAbove [currLayerId][i])
usedForRefFlag=1
   for (i=0; i<NumActiveRefLayerPics; i++)

if(RefPicLayerId[i]==layerId)
usedForRefFlag=1

When usedForRefFlag is equal to 0, IPic is marked as “unused for reference”.

The decoding process for starting the decoding of a coded picture with nuh_layer_id greater than 0 is invoked for decoding of the slice segment header of the first slice, in decoding order, of the current picture. The marking process for inter-layer reference pictures not needed for prediction identifies pictures with layer index less than the current layer and which are not needed for reference in its own layer by pictures following it in decoding order and by pictures in the current access unit at or above the current layer. These identified pictures are marked as “unused for reference”.

A modified DPB management process which marks pictures within the current access unit may include a modified signaling of the slice header and an invokation of an inter-layer picture marking process within the decoding process for ending the decoding of a coded picture with nuh_layer_id greater than 0. The inter-layer picture marking process may use information determined based on layer dependency information signaled in the VPS extension and information signaled in the slice header. Exemplary modifications are listed below:

A First, Slice Header Modificiation—Table (15)

TABLE(15)
De-
scrip-
tor

slice_segment_header( ) {

| | |
|---|---|
| ... | ue(v) |
| if( !dependent_slice_segment_flag ) { | |

i = 0
if( num_extra_slice_header_bits > i ) {

| | |
|---|---|
| i++ | |
| poc_reset_flag | u(1) |

}
if( num_extra_slice_header_bits > i ) {

| | |
|---|---|
| i++ | |
| discardable_flag | u(1) |

}
if( num_extra_slice_header_bits > i ) {

| | |
|---|---|
| i++ | |
| unused_for_pred_in_cur_layer_flag | u(1) |

}
for( i = 1 ; i < num_extra_slice_header_bits; i++ )

| | |
|---|---|
| slice_reserved_flag[ i ] | u(1) |

...
if( nuh_layer_id > 0 )

for( i=0; i<NumLayersReferencedAbove[
nuh_layer_id ]; i++)

if(UnusedForInterPredFlag[ LayerIdRefAbove[

nuh_layer_id ][ i ] ])

| | |
|---|---|
| used_for_pred_in_layers_above[ i ] | u(1) |

...

}
...

}

A Second, Semantic for Syntax Element Added to Slice Header:

used_for_pred_in_layers_above[i] equal to 1 specifies that the picture in the current access unit with nuh_layer_id equal to LayerIdRefAbove[nuh_layer_id][i] is used for inter-layer prediction (both pixel and motion) by a higher layer picture. used_for_pred_in_layers_above[i] equal to 0 specifies that the picture in the current access unit with nuh_layer_id equal to LayerIdRefAbove[nuh_layer_id][i] is not used for inter-layer prediction by a higher layer picture. When not present, the value of used i is inferred to be equal to 0.
The variable UsedForPredInLayersAbove[i][j] is derived as follows:
for (j=0; j<NumLayersReferencedAbove[nuh_layer_id]; j++)

UsedForPredInLayersAbove[nuh_layer_id][j]=used_for_pred_in_layers_above[j]

Note, the syntax element used_for_pred_in_layers_above[i] is only signalled if the picture corresponding to index i is not used for reference in its own layer by subsequent decoded pictures. This additional signalling of used used_for_pred_in_layers_above[i] helps accommodate any changes to the layer dependency information signaled in VPS, achieved with additional syntax elements signaled in the slice header. Specifically, any layer(s) which are not needed for inter-layer prediction earlier than that determined by layer dependency information in the VPS can be identified using used_for_pred_in_layers_above[i].
unused_for_pred_in_cur_layer_flag equal to 1 specifies that the current picture with nuh_layer_id equal to currLayerId is not used as a reference picture for inter prediction in the decoding process of subsequent pictures in decoding order with nuh_layer_id equal to currLayerId. unused_for_pred_in_cur_layer_flag equal to 0 specifies that the current picture with nuh_layer_id equal to currLayerId may be used as a reference picture for inter prediction in the decoding process of subsequent pictures in decoding order with nuh_layer_id equal to currLayerId. When not present, the value of unused_for_pred_in_cur_layer_flag is inferred to be equal to 0.
The variable UnusedForInterPredFlag is derived as follows:
UnusedForInterPredFlag[nuh_layer_id]=unused_for_pred_in_cur_layer_flag.
It is a requirement of bitstream conformance that the value of unused_for_pred_in_cur layer_flag shall be the same for all slices of a coded picture. Note in a variant embodiment, the syntax element unused_for_pred_in_cur_layer_flag may be signaled only within slice headers with nuh_layer_id greater than 0.

A Third, Information Determined from Layer Dependency Sytnax Elements Signaled in VPS Extension:

The variables NumLayersReferencedAboveE3[i] and LayerIdRefAboveE3[i][j] are derived as follows:

```
for( i = 0; i <= vps_max_layers_minus1; i++ ) {
    iNuhLId = layer_id_in_nuh[ i ]
    ...
    for( j = 0; j < i; j++ ) {
        ...
        NumLayersReferencedAboveE3[ iNuhLId ] = 0
        ReferencedFlag = 0
        for( k = i+1; k <= vps_max_layers_minus1 ; k++ )
            if (direct_dependency_flag[ k ][ j ] &&
            ReferencedFlag = = 0) {
                ReferencedFlag = 1
                LayerIdRefAboveE3[ iNuhLId ][
NumLayersReferencedAboveE3[ iNuhLId ]++ ] = layer_id_in_nuh[ j ]
            }
    }
}
```

The value of array element NumLayersReferencedAboveE3[i] is set equal to the number of layers with layer index less than LayerIdxInVPS[i] which may be used as a direct reference layer by layers with index greater than LayerIdxInVPS[i], where i is the nuh_layer_id of the current picture being decoded. The value of array element LayerIdRefAboveE3[x][y] is set equal to the nuh_layer_id of the y-th layer referenced by layers above the layer with nuh_layer_id x. These two array elements help identify layers below the current layer which may be used as direct reference by layers above the current layer. A flag is then signalled in the slice header indicating if the identified layer is used for reference in the current access unit.

A Fourth, Decoding Process Change

Decoding process for ending the decoding of a coded picture with nuh_layer_id greater than 0
PicOutputFlag is set as follows:

If the current picture is a RASL picture and NoRasIOutputFlag of the associated IRAP picture is equal to 1, PicOutputFlag is set equal to 0.

Otherwise, if LayerInitialisedFlag[nuh_layer_id] is equal to 0, PicOutputFlag is set equal to 0.

Otherwise, PicOutputFlag is set equal to pic_output_flag.

The following applies:

If discardable_flag is equal to 1, the decoded picture is marked as “unused for reference”.

Otherwise, the decoded picture is marked as “used for short-term reference”.

When TemporalId is equal to HighestTid, the marking process for sub-layer non-reference pictures not needed for inter-layer prediction is invoked with latestDecLayerId equal to nuh_layer_id as input.
FirstPicInLayerDecodedFlag[nuh_layer_id] is set equal to 1.
When NumLayersReferencedAboveE3[nuh_layer_id] is greater than 1, the marking process for inter-layer reference pictures not needed for prediction (listed below) is invoked with nuh_layer_id of current picture CurrPic as input.
Marking process for inter-layer reference pictures not needed for prediction
Input to this process is:

a nuh_layer_id value currLayerId

Output of this process is:

potentially updated marking as “unused for reference” for some decoded pictures For layerId in the range of 0 to currLayerId−1, inclusive, the following applies:
Let IPic be the picture in the current access unit with nuh_layer_id equal to layerId
When IPic is present in the decoded picture buffer, UnusedForInterPredFlag[layerId] is equal to 1, the following applies:
   The variable usedForInterLayerRefFlag is derived as specified in the following:
      usedForInterLayerRefFlag=0
      for (i=0; i<NumLayersReferencedAboveE3[currLayerId]; i++)

if(LayerIdRefAboveE3[currLayerId][i]==layerId && UsedForPredInLayersAbove[currLayerId][i])
usedForInterLayerRefFlag=1
When usedForiInterLayerRefFlag is equal to 0, IPic is marked as “unused for reference”.

The decoding process for ending the decoding of a coded picture with nuh_layer_id greater than 0 is invoked after all slices of the current picture have been decoded. The marking process for inter-layer reference pictures not needed for prediction identifies pictures with layer index less than the current layer and which are not needed for reference in its own layer by pictures following it in decoding order and by pictures in the current access unit above the current layer. These identified pictures are marked as “unused for reference”.

In one picture prediction configuration a picture in the current access unit with layer index x may be marked as “unused for reference” within the decoding process for starting the decoding of a coded picture with layer index (x+2). In an example the picture prediction configuration corresponds to the one illustrated in FIG. 9. The use of such a picture prediction structure by the bitsteam may be indicated by use of a syntax element in the VPS extension. An exemplary VPS extension is listed below in Table (16):

TABLE(16)
De-
scrip-
tor

vps_extension( ) {

| | |
|---|---|
| ... | |
| max_one_active_ref_layer_flag | u(1) |
| all_pics_irap_ilp_ref_once_flag | u(1) |
| cross_layer_irap_aligned_flag | u(1) |
| ... | |

}

all_pics_irap_ilp_ref_once_flag equal to 1 specifies that all pictures in the CVS are IRAP pictures and each picture is used for inter-layer reference within an access unit by another layer exactly once. all_pics_irap_ilp_ref_flag equal to 0 specifies that the above restriction shall not apply. When not present, all_pics_irap_ilp_ref_once_flag is inferred to be equal to 0.

In one picture prediction configuration a picture in current access unit with layer index x may be marked as “unused for reference” within decoding process for ending the decoding of a coded picture with layer index (x+1). In an example the picture prediction configuration corresponds to the one illustrated in FIG. 9. The use of such a picture prediction structure by the bitsteam may be indicated by use of a syntax element in the VPS extension. An exemplary VPS extension is listed in Table (17).

TABLE(17)
De-
scrip-
tor

vps_extension( ) {

| | |
|---|---|
| ... | |
| max_one_active_ref_layer_flag | u(1) |
| all_pics_irap_ilp_ref_once_flag | u(1) |
| cross_layer_irap_aligned_flag | u(1) |
| ... | |

}

all_pics_irap_ilp_ref_once_flag equal to 1 specifies that all pictures in the CVS are IRAP pictures and each picture is used for inter-layer reference within an access unit by another layer exactly once. all_pics_irap_ilp_ref_flag equal to 0 specifies that the above restriction shall not apply. When not present, all_pics_irap_ilp_ref_once_flag is inferred to be equal to 0.

In one inter and inter-layer prediction configuration all pictures are intra pictures. Every picture is used for inter-layer reference by the layer above except the picture at the highest layer. In such a configuration the picture in the current access unit at layer index x may be marked as “unused for reference” within the decoding process for starting the decoding of a coded picture with layer index (x+2). In an example the picture prediction configuration corresponds to the one illustrated in FIG. 9. The use of such a picture prediction structure by the bitsteam may be indicated by use of a syntax element in the VPS extension. An exemplary VPS extension is listed below in Table (18):

TABLE(18)
De-
scrip-
tor

vps_extension( ) {

| | |
|---|---|
| ... | |
| max_one_active_ref_layer_flag | u(1) |
| all_intra_snr_flag | u(1) |
| cross_layer_irap_aligned_flag | u(1) |
| ... | |

}

all_intra_snr_flag equal to 1 specifies that all pictures in the CVS are intra pictures and every picture is used for inter-layer reference by the layer above except the picture at the highest layer. all_intra_snr_flag equal to 0 specifies that the above restriction shall not apply. When not present, all_pics_irap_ilp_ref_once_flag is inferred to be equal to 0.

In one inter and inter-layer prediction configuration all pictures are intra pictures. Every picture is used for inter-layer reference by the layer above except the picture at the highest layer. In such a configuration the picture in the current access unit at layer index x may be marked as “unused for reference” within the decoding process for ending the decoding of a coded picture with layer index (x+1). In an example the picture prediction configuration corresponds to the one illustrated in FIG. 9. The use of such a picture prediction structure by the bitsteam may be indicated by use of a syntax element in the VPS extension. An exemplary VPS extension is listed in Table (19):

TABLE(19)
De-
scrip-
tor

vps_extension( ) {

| | |
|---|---|
| ... | |
| max_one_active_ref_layer_flag | u(1) |
| all_intra_snr_flag | u(1) |
| cross_layer_irap_aligned_flag | u(1) |
| ... | |

}

all_intra_snr_flag equal to 1 specifies that all pictures in the CVS are intra pictures and every picture is used for inter-layer reference by the layer above except the picture at the highest layer. all_intra_snr_flag equal to 0 specifies that the above restriction shall not apply. When not present, all_pics_irap_ilp_ref_once_flag is inferred to be equal to 0.

In one picture prediction configuration pictures in all previous access units can be marked as “unused for reference” within the decoding process for starting the decoding of a coded picture with nuh_layer_id equal to 0. The use of such a picture prediction structure by the bitsteam may be indicated by use of a syntax element in the VPS extension. In an example the syntax element all_pics_irap_ilp_ref_once_flag is used to signal the use of such a picture prediction structure. In another example the syntax element all_intra_snr_flag is used to signal the use of such a picture prediction structure.

In an example embodiment, when (the current picture is not an IRAP picture with NoRasIOutputFlag equal to 1 or with nuh_layer_id not equal to 0), all picture storage buffers containing a picture, which are marked as “not needed for output” and “unused for reference” are emptied (without output), independent of the layer to which the corresponding pictures belong. For each picture storage buffer that is emptied, the DPB fullness is decremented by one.

In an example embodiment, when (the current picture is not an IRAP picture with NoRasIOutputFlag equal to 1 or with nuh_layer_id not equal to 0), all picture storage buffers containing a picture of layers with index less than or equal to the current layer index, which are marked as “not needed for output” and “unused for reference” are emptied (without output). For each picture storage buffer that is emptied, the DPB fullness is decremented by one.

In another embodiment one or more of the syntax elements layer_dependency_information_pattern, layer_dependency_map may be signaled using a known fixed number of bits instead of u(v). For example they could be signaled using u(64).

In another embodiment one or more of or more of the syntax elements layer_dependency_information_pattern, layer_dependency_map may be signaled with ue(v) or some other coding scheme.

In another embodiment the names of various syntax elements and their semantics may be altered by adding a plus1 or plus2 or by subtracting a minus1 or a minus2 compared to the described syntax and semantics.

In yet another embodiment various syntax elements such as layer_dependency_information_pattern, layer_dependency_map, layer_dependency_flag[i] etc. may be signaled per picture anywhere in the bitstream. For example it may be signaled in slice header, pps/sps/vps/aps or any other parameter set or other normative part of the bitstream.

As previously described, scalable video coding is a technique of encoding a video bitstream that also contains one or more subset bitstreams. A subset video bitstream may be derived by dropping packets from the larger video to reduce the bandwidth required for the subset bitstream. The subset bitstream may represent a lower spatial resolution (smaller screen), lower temporal resolution (lower frame rate), or lower quality video signal. For example, a video bitstream may include 5 subset bitstreams, where each of the subset bitstreams adds additional content to a base bitstream. Hannuksela, et al., “Test Model for Scalable Extensions of High Efficiency Video Coding (HEVC)” JCTVC-L0453, Shanghai, October 2012, is hereby incorporated by reference herein in its entirety. Chen, et al., “SHVC Draft Text 1,” JCTVC-L1008, Geneva, March, 2013, is hereby incorporated by reference herein in its entirety.

As previously described, multi-view video coding is a technique of encoding a video bitstream that also contains one or more other bitstreams representative of alternative views. For example, the multiple views may be a pair of views for stereoscopic video. For example, the multiple views may represent multiple views of the same scene from different viewpoints. The multiple views generally contain a large amount of inter-view statistical dependencies, since the images are of the same scene from different viewpoints. Therefore, combined temporal and inter-view prediction may achieve efficient multi-view encoding. For example, a frame may be efficiently predicted not only from temporally related frames, but also from the frames of neighboring viewpoints. Hannuksela, et al., “Common specification text for scalable and multi-view extensions,” JCTVC-L0452, Geneva, January 2013, is hereby incorporated by reference herein in its entirety. Tech, et. al. “MV-HEVC Draft Text 3 (ISO/IEC 23008-2:201x/PDAM2),” JCT3V-C1004_d3, Geneva, January 2013, is hereby incorporated by reference herein in its entirety.

In another embodiment one or more of the syntax elements may be signaled using a known fixed number of bits instead of u(v) instead of ue(v). For example they could be signaled using u(8) or u(16) or u(32) or u(64), etc.

In another embodiment one or more of these syntax element could be signaled with ue(v) or some other coding scheme instead of fixed number of bits such as u(v) coding.

In another embodiment the names of various syntax elements and their semantics may be altered by adding a plus1 or plus2 or by subtracting a minus1 or a minus2 compared to the described syntax and semantics.

In yet another embodiment various syntax elements included in the output layer sets SEI message may be signaled per picture or at other frequency anywhere in the bitstream. For example they may be signaled in slice segment header, pps/sps/vps/adaptation parameter set or any other parameter set or other normative part of the bitstream.

In yet another embodiment various syntax elements may be signaled per picture or at other frequency anywhere in the bitstream. For example they may be signaled in slice segment header, pps/sps/vps/adaptation parameter set or any other parameter set or other normative part of the bitstream.

In yet another embodiments all the concepts defined in this invention related to output layer sets could be applied to output operation points as defined in JCTVC-L0452 and JCTVC-L0453 and/or to operation points as defined in JCTVC-L1003.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods or approaches described herein may be implemented in and/or realized using a chipset, an ASIC, a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

I/We claim:

1. A method for decoding a video bitstream comprising the steps of:
(a) receiving said video bitstream that includes a plurality of different layers;
(b) marking a plurality of pictures received for one of said different layers for at least two of which are marked for different ones of said different layers of said video bitstream.

2. The method of claim 1 where said marked pictures belong to a decoded picture buffer.

3. The method of claim 1 wherein said plurality of pictures are within the same access unit.

4. The method of claim 1 wherein a subset of said plurality of pictures are within the same access unit.

5. The method of claim 2 wherein each of said plurality of different layers is associated with at least one decoded picture buffer.

6. A method for decoding a video bitstream comprising the steps of:
(a) receiving said video bitstream that includes a plurality of different layers;
(b) removing at least one marked picture from a decoded picture buffer of a plurality of pictures received for one of said different layers of said video bitstream that are marked for different ones of said different layers.

7. The method of claim 6 wherein said plurality of pictures are within the same access unit.

8. The method of claim 6 wherein a subset of said plurality of pictures are within the same access unit

9. The method of claim 6 wherein each of said plurality of different layers is associated with at least one decoded picture buffer.

10. The method of claim 2 further comprising removing at least one said marked picture of said decoded picture buffer of said plurality of pictures received for one of said different layers of said video bitstream that are marked for different ones of said different layers.

11. The method of claim 10 wherein said plurality of pictures are within the same access unit.

12. The method of claim 10 wherein a subset of said plurality of pictures are within the same access unit.

13. The method of claim 10 wherein each of said plurality of different layers is associated with at least one decoded picture buffer.

14. The method of claim 5 further comprising removing at least one said marked picture of said decoded picture buffer of said plurality of pictures received for one of said different layers of said video bitstream that are marked for different ones of said different layers.

15. The method of claim 14 wherein said plurality of pictures are within the same access unit.

16. The method of claim 14 wherein a subset of said plurality of pictures are within the same access unit.

17. The method of claim 14 wherein each of said plurality of different layers is associated with at least one decoded picture buffer.

18. A method for decoding a video bitstream comprising the steps of:
(a) receiving said video bitstream that includes a plurality of different layers;
(b) removing at least one marked picture from a decoded picture buffer of at least one picture received for one of said different layers of said video bitstream that is marked for different ones of said different layers.

19. The method of claim 18 wherein each of said plurality of different layers is associated with at least one decoded picture buffer.
